(19) United States
(12) Patent Application Publication
(10) Pub. No.: US 2025/0038836 A1
(43) Pub. Date: Jan. 30, 2025

(54) SATELLITE ASSISTANCE INFORMATION OBTAINING METHOD, DEVICE, AND READABLE STORAGE MEDIUM

(71) Applicant: VIVO MOBILE COMMUNICATION CO., LTD., Dongguan (CN)

(72) Inventors: Ranran HE, Dongguan (CN); Yanxia ZHANG, Dongguan (CN)

(73) Assignee: VIVO MOBILE COMMUNICATION CO., LTD., Dongguan (CN)

(21) Appl. No.: 18/912,557

(22) Filed: Oct. 10, 2024

Related U.S. Application Data
(63) Continuation of application No. PCT/CN2023/087021, filed on Apr. 7, 2023.

(30) Foreign Application Priority Data
Apr. 11, 2022 (CN) 202210377418.9

(51) Int. Cl. H04B 7/185

(52) U.S. Cl. CPC H04B 7/18513; H04B 7/1855; H04B 7/18589

(57) ABSTRACT

This application discloses a satellite assistance information obtaining method, a device, and a readable storage medium. The method includes: a terminal obtains a first message and a second message, and the terminal determines satellite assistance information for a target cell or a target frequency according to the first message and/or the second message. The first message includes at least one piece of satellite assistance information, and the second message includes satellite assistance information for a serving cell. The target cell is a neighboring cell of the serving cell, the target frequency is a neighboring frequency of a serving frequency, and the serving frequency is a frequency of the serving cell. The satellite assistance information in the first message is associated with at least one cell, or the satellite assistance information in the first message is associated with at least one frequency.

### CROSS-REFERENCE TO RELATED APPLICATIONS

This application is a continuation of International Application No. PCT/CN 2023/087021, filed on Apr. 7, 2023, which claims priority to Chinese Patent Application No. 202210377418.9, filed on Apr. 11, 2022. The entire contents of each of the above-referenced applications are expressly incorporated herein by reference.

### TECHNICAL FIELD

This application pertains to the technical field of communications, and in particular, to a satellite assistance information obtaining method, a device, and a readable storage medium.

### BACKGROUND

At present, in a Non-Terrestrial Networks (NTN), a network can broadcast satellite assistance information for a serving cell and validity time of the satellite assistance information for the serving cell only through a system broadcast message. However, in the NTN, satellite assistance information for a neighboring cell or a neighboring frequency is also very important for a terminal. In a case that the terminal cannot obtain the satellite assistance information for the neighboring cell or the neighboring frequency, the terminal may fail to measure some neighboring cells, which affects mobility management.

### SUMMARY

Embodiments of this application provide a satellite assistance information obtaining method, a device, and a readable storage medium, to resolve a problem that a terminal cannot obtain satellite assistance information for a neighboring cell or a neighboring frequency.

According to a first aspect, a satellite assistance information obtaining method is provided, and includes:

A terminal obtains a first message and a second message, where the first message includes at least one piece of satellite assistance information, and the second message includes satellite assistance information for a serving cell.

The terminal determines satellite assistance information for a target cell or a target frequency according to the first message and/or the second message, where the target cell is a neighboring cell of the serving cell, the target frequency is a neighboring frequency of a serving frequency, and the serving frequency is a frequency of the serving cell.

The satellite assistance information in the first message is associated with at least one cell, or the satellite assistance information in the first message is associated with at least one frequency.

According to a second aspect, a satellite assistance information obtaining apparatus is provided, and includes:
an obtaining module, configured to obtain a first message and a second message by a terminal, where the first message includes at least one piece of satellite assistance information, and the second message includes satellite assistance information for a serving cell; and
a determining module, configured to determine satellite assistance information for a target cell or a target frequency according to the first message and/or the second message by the terminal, where the target cell is a neighboring cell of the serving cell, the target frequency is a neighboring frequency of a serving frequency, and the serving frequency is a frequency of the serving cell, where
the satellite assistance information in the first message is associated with at least one cell, or the satellite assistance information in the first message is associated with at least one frequency.

According to a third aspect, a terminal is provided. The terminal includes a processor and a memory, the memory stores a program or an instruction that is executable on the processor, and the program or the instruction is executed by the processor to implement the steps of the method according to the first aspect.

According to a fourth aspect, a terminal is provided, and includes a processor and a communication interface. The communication interface is configured to obtain a first message and a second message by the terminal, where the first message includes at least one piece of satellite assistance information, and the second message includes satellite assistance information for a serving cell.

The processor is configured to determine satellite assistance information for a target cell or a target frequency according to the first message and/or the second message by the terminal, where the target cell is a neighboring cell of the serving cell, the target frequency is a neighboring frequency of a serving frequency, and the serving frequency is a frequency of the serving cell.

The satellite assistance information in the first message is associated with at least one cell, or the satellite assistance information in the first message is associated with at least one frequency.

According to a fifth aspect, a readable storage medium is provided. The readable storage medium stores a program or an instruction, and the program or the instruction is executed by a processor to implement the steps of the method according to the first aspect.

According to a sixth aspect, a chip is provided. The chip includes a processor and a communication interface, the communication interface is coupled to the processor, and the processor is configured to run a program or an instruction to implement the steps of the method according to the first aspect.

According to a seventh aspect, a computer program/program product is provided. The computer program/program product is stored in a storage medium, and the computer program/program product is executed by at least one processor to implement the steps of the method according to the first aspect.

In the embodiments of this application, the terminal determines the satellite assistance information for the target cell or the target frequency according to the first message including the at least one piece of satellite assistance information and/or the second message including the satellite assistance information for the serving cell, so that the terminal can obtain the satellite assistance information for the neighboring cell (or the neighboring frequency) through the first message and the second message, to ensure correctness of mobility management of the terminal.

### BRIEF DESCRIPTION OF DRAWINGS

FIG. 1 is a schematic diagram of a network architecture of an NTN;

FIG. 2 is a schematic flowchart of a satellite assistance information obtaining method according to an embodiment of this application;

FIG. 3 is a schematic diagram of a structure of a satellite assistance information obtaining apparatus according to an embodiment of this application;

FIG. 4 is a schematic diagram of a structure of a communications device according to an embodiment of this application; and

FIG. 5 is a schematic diagram of a structure of a terminal according to an embodiment of this application.

### DETAILED DESCRIPTION

The following clearly describes the technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the specification and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to applications other than the NR system application, such as a 6^{th} Generation (6G) communication system.

A block diagram of a wireless communication system to which the embodiments of this application are applicable is provided. The wireless communication system includes a terminal and a network side device. The terminal may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal is not limited in the embodiments of this application. The network side device may include an access network device or a core network device. The access network device may also be referred to as a radio access network device, a Radio Access Network (RAN), a radio access network function, or a radio access network unit. The access network device may include a base station a Wireless Local Area Network (WLAN) access node, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

To better understand the technical solutions in the embodiments of this application, the following content is first described:

### 1. Brief Introduction for NTN

A non-terrestrial network is a network or network segment in which transmission is performed by using a satellite or an Unmanned Aircraft System (UAS) platform. Compared with a terrestrial communication system, a satellite-based non-terrestrial communication system has a wider coverage area. Applicable typical scenarios include cases that a ground base station cannot be constructed and a ground base station is damaged, for example, continuous coverage in remote mountains, deserts, oceans, and forests, or emergency communication when a natural disaster occurs or a ground base station is damaged.

Satellites include a Low Earth Orbiting (LEO) satellite, a Medium Earth Orbiting (MEO) satellite, a Geostationary Earth Orbiting (GEO) satellite, and a Highly Elliptical Orbiting (HEO) satellite.

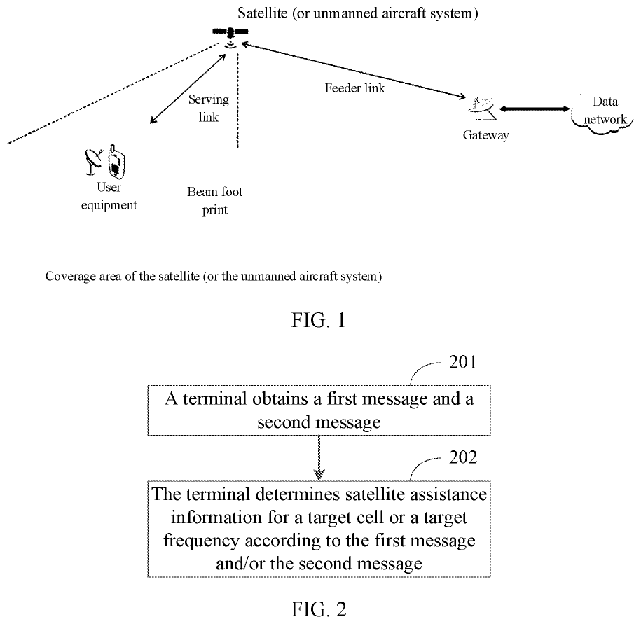

Typical scenarios of the non-terrestrial network include transparent forwarding, that is, the satellite serves as a forwarding relay device. As shown in FIG. 1, the typical scenarios of the non-terrestrial network further include signal regeneration, that is, the satellite directly serves as a base station.

For the transparent forwarding, a link between the satellite and a terminal is a serving link, and a link between the satellite and a ground base station is a feeder link.

### 2. Serving Cell Ephemeris Information

Satellite assistance information for a serving cell may be broadcast through a system broadcast message, including the following content:
(1) an ephemeris (Ephemeris), where the ephemeris includes a satellite ephemeris, and the satellite ephemeris may be expressed in a format of location and velocity state vectors, or may be expressed in a format of an orbital parameter;
(2) a common timing Advance (TA) parameter (common TA parameters), indicating information for a terminal to calculate a timing advance;
(3) validity duration of uplink synchronization information (ntnUlSyncValidityDuration);
(4) t-Service, indicating cell service stop time;
(5) a cell reference location;
(6) epoch time (Epoch time);
(7) polarization information for downlink transmission, including left-handed polarization, right-handed polarization, and linear polarization;
(8) polarization information for uplink transmission, including left-handed polarization, right-handed polarization, and linear polarization;
(9) a timing advance reporting indication, instructing the terminal to report the timing advance;
(10) K_mac, indicating a scheduling offset provided by a network in a case that frame timing of a downlink is inconsistent with frame timing of an uplink on a gNB; and
(11) CellSpecific_K_offset, indicating a scheduling offset for modifying a timing relationship in an NTN.

The epoch time and ntnUlSyncValidityDuration constitute validity time of the satellite assistance information for the serving cell, namely, a period of time with the epoch time as a start point and a length of ntnUlSyncValidityDuration for, indicating longest time for the terminal to apply assistance information without obtaining new assistance information. In a case that the validity time expires, the terminal needs to re-obtain the satellite assistance information.

With reference to the accompanying drawings, a satellite assistance information obtaining method provided in the embodiments of this application is described in detail by using some embodiments and application scenarios thereof.

Refer to FIG. 2. A satellite assistance information obtaining method provided in an embodiment of this application includes the following steps:

Step 201: A terminal obtains a first message and a second message, where the first message includes at least one piece of satellite assistance information, and the second message includes satellite assistance information for a serving cell. For example, the terminal may obtain the first message and the second message through a System Information Block (SIB) that is broadcast by a network side. The first message and the second message may be a same message, or the first message and the second message may be different messages.

Step 202: The terminal determines satellite assistance information for a target cell or a target frequency according to the first message and/or the second message, where the target cell is a neighboring cell of the serving cell, the target frequency is a neighboring frequency of a serving frequency, and the serving frequency is a frequency of the serving cell.

The satellite assistance information in the first message is associated with at least one cell, or the satellite assistance information in the first message is associated with at least one frequency.

In some embodiments, that the satellite assistance information in the first message is associated with at least one cell means that the satellite assistance information in the first message may be satellite assistance information for a cell (or a cell group), in other words, the satellite assistance information in the first message may be broadcast and sent per cell (or per cell group) (per cell/per cell group). That the satellite assistance information in the first message is associated with at least one frequency means that the satellite assistance information in the first message may be satellite assistance information for a frequency, in other words, the satellite assistance information in the first message may be broadcast and sent per frequency (per frequency).

In some embodiments, that the first message includes at least one piece of satellite assistance information may be understood as that the first message includes at least one piece of NTN neighboring cell related information (for example, at least one of ntn-NeighCellConfigList and ntn-NeighCellConfigListExt).

In some embodiments, that the second message includes satellite assistance information for a serving cell may be that the second message includes NTN configuration information for the serving cell (for example, ntn-Config).

In some embodiments, that the terminal determines satellite assistance information for a target cell or a target frequency according to the first message and/or the second message may be understood as that the terminal determines the satellite assistance information for the target cell or the target frequency (for example, a carrier frequency of the target cell, carrierFrequcency) according to at least one of the first message and the second message. The satellite assistance information for the target cell or the target frequency may include a physical cell identifier (for example, phyCellID).

In some embodiments, the satellite assistance information includes at least one of the following:
(1) ephemeris information, where the ephemeris information includes a satellite ephemeris, and the satellite ephemeris may be expressed in a format of location and velocity state vectors, or may be expressed in a format of an orbital parameter;
(2) a common TA parameter (common TA parameters), indicating information for the terminal to calculate a timing advance;
(3) polarization information for downlink transmission, whose value includes left-handed polarization, right-handed polarization, and linear polarization;
(4) polarization information for uplink transmission, whose value includes left-handed polarization, right-handed polarization, and linear polarization;
(5) a timing advance reporting indication, instructing the terminal to report the timing advance;
(6) timing advance related information, including the information for the terminal to calculate the timing advance;
(7) K_mac, indicating a scheduling offset provided by a network in a case that frame timing of a downlink is inconsistent with frame timing of an uplink on a gNB;
(8) CellSpecific_K_offset, indicating a scheduling offset for modifying a timing relationship in an NTN;
(9) t-Service, indicating cell service stop time;
(10) a cell reference location;
(11) epoch time (Epoch time); and
(12) validity duration of uplink synchronization information (ntnUlSyncValidityDuration).

In this embodiment of this application, the terminal determines the satellite assistance information for the target cell or the target frequency according to the first message including the at least one piece of satellite assistance information and/or the second message including the satellite assistance information for the serving cell, so that the terminal can obtain satellite assistance information for a neighboring cell (or a neighboring frequency), to ensure correctness of mobility management of the terminal.

In a possible implementation, that the terminal determines the satellite assistance information for the target cell or the target frequency according to the first message and/or the second message in a case that the satellite assistance information in the first message is associated with the at least one cell includes any one of the following:

(A1) The terminal determines the satellite assistance information for the target cell according to a first list or a second list, where the first list includes first satellite assistance information, the first satellite assistance information includes satellite assistance information for at least one intra-frequency neighboring cell, the second list includes second satellite assistance information, the second satellite assistance information includes satellite assistance information for at least one inter-frequency neighboring cell, a frequency of the intra-frequency neighboring cell is the same as the serving frequency, and a frequency of the inter-frequency neighboring cell is different from the serving frequency.

In this embodiment of this application, neighboring cells may be classified into the intra-frequency neighboring cell and the inter-frequency neighboring cell based on whether a neighboring cell is at a same frequency as the serving cell, and satellite assistance information provided by a corresponding network side may be correspondingly classified into satellite assistance information for the intra-frequency neighboring cell and satellite assistance information for the inter-frequency neighboring cell. The first list consists of satellite assistance information for all intra-frequency neighboring cells (where elements in the first list may be the same or different, and the same elements mean that there are multiple cells with same satellite assistance information). The second list consists of satellite assistance information for all inter-frequency neighboring cells. The terminal determines specific satellite assistance information for all the neighboring cells according to the first list or the second list.

(A2) The terminal determines the satellite assistance information for the target cell according to a third list or a fourth list, where the third list includes first satellite assistance information, the first satellite assistance information includes satellite assistance information for at least one intra-frequency neighboring cell, the fourth list includes third satellite assistance information, the third satellite assistance information includes satellite assistance information for at least one neighboring cell, a frequency of the at least one neighboring cell is a first frequency, and the first frequency is different from the serving frequency.

In this embodiment of this application, the third list consists of satellite assistance information for all intra-frequency neighboring cells. For the inter-frequency neighboring cell, the fourth list including the satellite assistance information for the at least one neighboring cell is formed according to different frequencies. The frequency of the at least one neighboring cell is the first frequency. The terminal determines specific satellite assistance information for all the neighboring cells according to the third list or the fourth list.

(A3) The terminal determines the satellite assistance information for the target cell according to a fifth list, where the fifth list includes fourth satellite assistance information, and the fourth satellite assistance information includes satellite assistance information for at least one neighboring cell.

In this embodiment of this application, the fifth list is obtained by merging satellite assistance information for all intra-frequency neighboring cells and satellite assistance information for all inter-frequency neighboring cells. The terminal determines specific satellite assistance information for all the neighboring cells according to the fifth list.

(A4) The terminal determines the satellite assistance information for the target cell according to a sixth list, where the sixth list includes fifth satellite assistance information, and the fifth satellite assistance information includes the satellite assistance information for the serving cell and satellite assistance information for at least one neighboring cell.

In this embodiment of this application, different from (A1) to (A3) in which an independent Information Element (IE) is used for the satellite assistance information for the neighboring cell and the satellite assistance information for the serving cell, (A4) is that the satellite assistance information for the neighboring cell and the satellite assistance information for the serving cell share one IE and the sixth list is obtained by merging the satellite assistance information for the serving cell, satellite assistance information for all intra-frequency neighboring cells, and satellite assistance information for all inter-frequency neighboring cells, in other words, a list including satellite assistance information for all cells is obtained through merging. The terminal determines specific satellite assistance information for all the neighboring cells according to the sixth list.

In the manners of (A1) to (A4) above, the terminal can determine the specific satellite assistance information for all the neighboring cells according to different neighboring cell classification manners in a case that the satellite assistance information is broadcast per cell (or per cell group).

In a possible implementation, that the terminal determines the satellite assistance information for the target cell or the target frequency according to the first message and/or the second message in a case that the satellite assistance information in the first message is associated with the at least one frequency includes any one of the following:

(B1) The terminal determines the satellite assistance information for the target cell or the target frequency according to a seventh list and an eighth list, where the seventh list includes sixth satellite assistance information, the sixth satellite assistance information includes satellite assistance information for at least one neighboring frequency, the neighboring frequency is different from the serving frequency, the eighth list includes at least one piece of first information, and the first information indicates at least one neighboring cell corresponding to each of the at least one neighboring frequency.

In this embodiment of this application, because the satellite assistance information in the first message is associated with the frequency, correspondingly, for the inter-frequency neighboring cell with a frequency different from the frequency of the serving cell, each neighboring frequency may correspond to one or more neighboring cells with the same frequency based on that the frequency is correspondingly at least one neighboring frequency different from the serving frequency. The seventh list consists of satellite assistance information for all neighboring frequencies. Further, the eighth list may consist of the at least one neighboring cell corresponding to each neighboring frequency. The terminal determines, according to the seventh list and the eighth list, all the neighboring frequencies and specific satellite assistance information for the neighboring cells corresponding to the neighboring frequencies.

(B2) The terminal determines the satellite assistance information for the target cell or the target frequency according to an eighth list and a ninth list, where the ninth list includes seventh satellite assistance information, the seventh satellite assistance information includes satellite assistance information for the serving frequency and satellite assistance information for at least one neighboring frequency, the neighboring frequency is different from the serving frequency, the eighth list includes at least one piece of first information, and the first information indicates at least one neighboring cell corresponding to each of the at least one neighboring frequency.

In this embodiment of this application, the ninth list consists of the satellite assistance information for the serving frequency and satellite assistance information for all neighboring frequencies. Further, the eighth list may consist of the at least one neighboring cell corresponding to each neighboring frequency. The terminal determines, according to the eighth list and the ninth list, all the neighboring frequencies and specific satellite assistance information for the neighboring cells corresponding to the neighboring frequencies.

It should be noted that in a case that a frequency of the target cell is the target frequency, the satellite assistance information for the target cell is the satellite assistance information for the target frequency.

In the manners of B1 and B2 above, the terminal can determine all the neighboring frequencies and the specific satellite assistance information for the neighboring cells corresponding to the neighboring frequencies according to different neighboring frequency classification manners in a case that the satellite assistance information is broadcast per frequency.

In some embodiments, the fifth list may be an NTN neighboring cell configuration list (for example, ntn-NeighCellConfigList or ntn-NeighCellConfigListExt), the fifth list includes the fourth satellite assistance information, and the fourth satellite assistance information includes the satellite assistance information for the at least one neighboring cell (for example, a carrier frequency carrierFreq and/or a physical cell identifier phyCellId corresponding to the neighboring cell).

In an implementation, (A1) that the terminal determines the satellite assistance information for the target cell according to a first list or a second list includes any one of the following:

(A1.1) In a case that the target cell is an intra-frequency neighboring cell, the terminal determines the satellite assistance information for the target cell according to the first list and a tenth list, where the tenth list includes information about at least one intra-frequency neighboring cell, and i^{th} satellite assistance information in the first list corresponds to i^{th} information in the tenth list.

In this embodiment of this application, an implicit association manner is provided to determine the satellite assistance information for the target cell. Specifically, for the intra-frequency neighboring cell, the satellite assistance information in the first list successively corresponds one-to-one to the information about the intra-frequency neighboring cell in the tenth list in an order agreed in a protocol. In a case that an element, in the first list, corresponding to a piece of information in the tenth list is empty, it indicates that the network does not provide satellite assistance information for this cell.

For example, the tenth list may be an IntraFreqNeighCellList in a SIB3 or a list that is of information about an intra-frequency neighboring cell and that is at least partially the same as the IntraFreqNeighCellList in another system message.

For example, in an implementation, the first list is intraFreq-NTN-ConfigNeighCellList={NTN-configNeighCell1, NTN-configNeighCell2, . . . , NTN-configNeighCelli, . . . }, IntraFreqNeighCellList={IntraFreqNeighCellInfo1, IntraFreqNeighCellInfo2, . . . , IntraFreqNeighCellInfo i, . . . }. In a case that the Physical Cell Identifier (PCI) of the target cell is in IntraFreqNeighCellInfo i, the satellite assistance information for the target cell is NTN-configNeighCell i.

In another implementation, an i^{th} element in the first list and an i^{th} element in the tenth list may be in a same field, to indicate that satellite assistance information for a cell corresponding to the i^{th} element in the tenth list is the i^{th} element in the first list, in other words, in a case that the PCI of the target cell is in the i^{th} element in the tenth list, the satellite assistance information for the target cell is the i^{th} element in the first list.

(A1.2) In a case that the target cell is an inter-frequency neighboring cell, the terminal determines the satellite assistance information for the target cell according to the second list and an eleventh list, where the eleventh list includes information about at least one inter-frequency neighboring cell and information about a frequency related to the at least one inter-frequency neighboring cell, and j^{th} satellite assistance information in the second list corresponds to j^{th} information in the eleventh list.

In this embodiment of this application, an implicit association manner is provided to determine the satellite assistance information for the target cell. Specifically, for the inter-frequency neighboring cell, the satellite assistance information in the second list successively corresponds one-to-one to the information about the inter-frequency neighboring cell in the eleventh list in an order agreed in a protocol. In a case that an element, in the second list, corresponding to a piece of information in the eleventh list is empty (or is absent), it indicates that the network does not provide satellite assistance information for this cell, or it indicates that this cell has no satellite assistance information, or it indicates that this cell is a terrestrial network (Terrestrial Networks, TN) cell.

It should be noted that because the eleventh list includes the information about the at least one inter-frequency neighboring cell and the information about the frequency related to the at least one inter-frequency neighboring cell, that is, the eleventh list is a two-dimensional list (including a frequency dimension and a dimension of a neighboring cell corresponding to a frequency). Correspondingly, the j^{th} information in the eleventh list may be information about a neighboring cell with an index (index) value of j in the eleventh list. Specifically, an index value in the eleventh list may be: index=d1+ . . . d(m−1)+n, where d(x) represents a quantity of entries (entry) of neighboring cells corresponding to each frequency. For example, assuming that the eleventh list includes three frequencies, and each frequency corresponds to three neighboring cells, an index of a 2^{nd} neighboring cell corresponding to a 3^{rd} frequency is: index=3(quantity of entries of neighboring cells corresponding to a 1^{st} frequency)+3(quantity of entries of neighboring cells corresponding to a 2^{nd} frequency)+2(quantity of entries of the 2^{nd} neighboring cell corresponding to the 3^{rd} frequency)=8.

For example, the eleventh list may be an InterFreqCarrierFreqList in a SIB4 or a list that is of information about an inter-frequency neighboring cell and that is at least partially the same as the InterFreqCarrierFreqList, and the list is broadcast in another system message (except a system message of the SIB4).

For example, in an implementation, the second list is interFreq-NTN-ConfigNeighCellList={NTN-configNeighCell1, NTN-configNeighCell2, . . . , NTN-configNeighCellj, . . . }, and the eleventh list is InterFreqCarrierFreqList={InterFreqCarrierFreqInfo1, InterFreqCarrierFreqInfo2, . . . , InterFreqCarrierFreqInfo m, . . . }, InterFreqCarrierFreqInfo={InterFreqNeighCellList, other information related to the frequency}, InterFreqNeighCellList={InterFreqNeighCellInfo 1, InterFreqNeighCellInfo 2, . . . , InterFreqNeighCellInfo n, . . . }. In a case that the PCI of the target cell is in InterFreqNeighCellInfo with the index 1=j, the satellite assistance information for the target cell is NTN-configNeighCell j.

In another implementation, the j^{th} element in the second list and the j^{th} element in the eleventh list may be in a same field, to indicate that satellite assistance information for a cell corresponding to the j^{th} element in the eleventh list is the j^{th} element in the second list, in other words, in a case that the PCI of the target cell is in the j^{th} element in the eleventh list, the satellite assistance information for the target cell is the j^{th} element in the second list, that is, an element in the same field as an element in the eleventh list.

i, j, m, and n are all positive integers.

In a possible implementation, (A2) that the terminal determines the satellite assistance information for the target cell according to a third list or a fourth list includes any one of the following:

(A2.1) In a case that the target cell is an intra-frequency neighboring cell, the terminal determines the satellite assistance information for the target cell according to the third list and a tenth list, where the tenth list includes information about at least one intra-frequency neighboring cell, and i^{th} satellite assistance information in the third list corresponds to i^{th} information in the tenth list.

In this embodiment of this application, an implicit association manner is provided to determine the satellite assistance information for the target cell. Specifically, for the intra-frequency neighboring cell, the satellite assistance information in the third list successively corresponds one-to-one to the information about the intra-frequency neighboring cell in the tenth list in an order agreed in a protocol. In a case that an element, in the third list, corresponding to a piece of information in the tenth list is empty (or is absent), it indicates that the network does not provide satellite assistance information for this cell, or it indicates that this cell has no satellite assistance information, or it indicates that this cell is a TN cell.

(A2.2) In a case that a frequency of the target cell is the first frequency, the terminal determines the satellite assistance information for the target cell according to the fourth list and a twelfth list, where the twelfth list includes information about the at least one neighboring cell corresponding to the first frequency, and j^{th} satellite assistance information in the fourth list corresponds to j^{th} information in the twelfth list. In a case that an element, in the fourth list, corresponding to a piece of information in the twelfth list is empty (or is absent), it indicates that the network does not provide satellite assistance information for this cell, or it indicates that this cell has no satellite assistance information, or it indicates that this cell is a TN cell.

In this embodiment of this application, an implicit association manner is provided to determine the satellite assistance information for the target cell. Specifically, for the inter-frequency neighboring cell, the satellite assistance information in the fourth list successively corresponds one-to-one to the information about the at least one neighboring cell corresponding to the first frequency in the twelfth list in an order agreed in a protocol. In the case that the element, in the fourth list, corresponding to the piece of information in the twelfth list is empty (or is absent), it indicates that the network does not provide the satellite assistance information for the cell, or it indicates that the cell has no satellite assistance information, or it indicates that the cell is the TN cell.

The twelfth list may be an InterFreqNeighCellList in a SIB4 or a list that is of information about an inter-frequency neighboring cell and that is at least partially the same as the InterFreqNeighCellList in another system message (except a system message of the SIB4).

For example, in an implementation, the fourth list is intraFreq-NTN-ConfigNeighCellList 1={NTN-configNeighCell1, NTN-configNeighCell2, . . . , NTN-configNeighCellj, . . . }, and the twelfth list is InterFreqNeighCellList={InterFreqNeighCellInfo1, InterFreqNeighCellInfo2, . . . , InterFreqNeighCellInfo j, . . . }. In a case that the PCI of the target cell is in InterFreqNeighCellInfo i, the satellite assistance information for the target cell is NTN-configNeighCell j. It should be noted that in this embodiment, at least one fourth list and at least one twelfth list are present.

In another implementation, the j^{th} element in the fourth list and the j^{th} element in the twelfth list may be in a same field, to indicate that satellite assistance information for a cell corresponding to the j^{th} element in the twelfth list is the j^{th} element in the fourth list, in other words, in a case that the PCI of the target cell is in the j^{th} element in the twelfth list, the satellite assistance information for the target cell is the j^{th} element in the fourth list, that is, an element in the same field as an element in the twelfth list. It should be noted that in this embodiment, at least one fourth list and at least one twelfth list are present.

Both i and j are positive integers.

In a possible implementation, (A3) that the terminal determines the satellite assistance information for the target cell according to a fifth list includes any one of the following:

(A3.1) The terminal determines the satellite assistance information for the target cell according to the fifth list and a thirteenth list, where the thirteenth list includes information about at least one neighboring cell, and i^{th} satellite assistance information in the fifth list corresponds to i^{th} information in the thirteenth list.

In this embodiment of this application, an implicit association manner is provided to determine the satellite assistance information for the target cell. Specifically, for the intra-frequency neighboring cell and the inter-frequency neighboring cell, the satellite assistance information in the fifth list successively corresponds one-to-one to the information about the neighboring cell in the thirteenth list in an order agreed in a protocol. In a case that an element, in the fifth list, corresponding to a piece of information in the thirteenth list is empty (or is absent), it indicates that the network does not provide satellite assistance information for this cell, or it indicates that this cell has no satellite assistance information, or it indicates that this cell is a TN cell.

In some embodiments, it should be noted that the i^{th} information in the thirteenth list may be information about a neighboring cell with an index (index) value of i in the thirteenth list. For example, an index value in the thirteenth list may be: index=x+d(x−y+1)+ . . . d(x−y+m−1)+n, where x represents an x^{th} intra-frequency neighboring cell element in the thirteenth list, y represents a quantity of intra-frequency neighboring cell elements in the thirteenth list, and d(z) represents a quantity of entries (entry) of neighboring cells corresponding to each frequency.

For example, the thirteenth list may be a list consisting of an IntraFreqNeighCellList in a SIB3 and an interFreq-NTN-ConfigNeighCellList in a SIB4, or may be a list consisting of first information and second information. The first information is information that is about an intra-frequency neighboring cell and that is at least partially the same as the IntraFreqNeighCellList in the SIB3. The second information is information that is about an inter-frequency neighboring cell and that is at least partially the same as the InterFreqCarrierFreqList in the SIB4.

For example, in an implementation, the fifth list is NTN-ConfigNeighCellList={NTN-configNeighCell1, NTN-configNeighCell2, . . . , NTN-configNeighCellj,}, and the thirteenth list is NeighCellList={IntraFreqNeighCellInfo1, IntraFreqNeighCellInfo 2, . . . , IntraFreqNeighCellInfo y, . . . {InterFreqNeighCellInfo 1, InterFreqNeighCellInfo 2, . . . , InterFreqNeighCellInfo n1}1, . . . {InterFreqNeighCellInfo 1, InterFreqNeighCellInfo 2, . . . , InterFreqNeighCellInfo nm}m, . . . }. In a case that the PCI of the target cell is in the thirteenth list with the index=i, the satellite assistance information for the target cell is NTN-configNeighCell i.

In another implementation, the i^{th} element in the fifth list and the i^{th} element in the thirteenth list may be in a same field, to indicate that satellite assistance information for a cell corresponding to the i^{th} element in the thirteenth list is the i^{th} element in the fifth list, in other words, in a case that the PCI of the target cell is in the i^{th} element in the thirteenth list, the satellite assistance information for the target cell is the i^{th} element in the fifth list, that is, an element in the same field as an element in the thirteenth list.

Both i and j are positive integers.

(A3.2) The terminal determines the satellite assistance information for the target cell according to the fifth list, a first indication list, and a second indication list, where the first indication list includes an index (index) or a bitmap (bitmap) corresponding to at least one intra-frequency neighboring cell, the second indication list includes an index or a bitmap corresponding to at least one inter-frequency neighboring cell, an i^{th} index or bitmap in the first indication list indicates that an i^{th} intra-frequency neighboring cell corresponds to m^{th} satellite assistance information in the fifth list, m corresponds to indicated content of the i^{th} index or bitmap, a j^{th} index or bitmap in the second indication list indicates that a j^{th} inter-frequency neighboring cell corresponds to n^{th} satellite assistance information in the fifth list, and n corresponds to indicated content of the j^{th} index or bitmap.

In this embodiment of this application, an explicit association manner is provided to determine the satellite assistance information for the target cell. Specifically, for the intra-frequency neighboring cell and the inter-frequency neighboring cell, the first indication list consisting of the index or the bitmap (bitmap) corresponding to the intra-frequency neighboring cell, and the second indication list consisting of the index or the bitmap corresponding to the inter-frequency neighboring cell are provided.

The i^{th} index or bitmap in the first indication list correspondingly indicates the m^{th} satellite assistance information in the fifth list, and m corresponds to the indicated content of the i^{th} index or bitmap. For example, the i^{th} index is 2, and then correspondingly indicates 2^{nd} satellite assistance information in the fifth list. For each bitmap, a 1^{st}/leftmost bit corresponds to 1^{st} satellite assistance information in the fifth list, a 2^{nd} bit corresponds to 2^{nd} satellite assistance information in the fifth list, and so on. For example, the i^{th} bitmap is 010000 . . . (whose quantity of bits is the same as a quantity of pieces of information in the fifth list), and then correspondingly indicates the 2^{nd} satellite assistance information in the fifth list.

Similarly, the j^{th} index or bitmap in the second indication list correspondingly indicates the n^{th} satellite assistance information in the fifth list, and n corresponds to the indicated content of the j^{th} index or bitmap.

One implementation for (A3.2):

For example, the fifth list is NTN-ConfigNeighCellList={NTN-configNeighCell1, NTN-configNeighCell2, . . . , NTN-configNeighCell m . . . }, and the first indication list is {bitmap 1, . . . , bitmap i, . . . }, where bitmap i=0000 . . . 1(m^{th})000 . . . represents that satellite assistance information for an i^{th} cell is NTN-configNeighCell m, the i^{th} cell is an i^{th} element in the tenth list, the tenth list may be an IntraFreqNeighCellList in a SIB3 or a list that is of information about an intra-frequency neighboring cell and that is at least partially the same as the IntraFreqNeighCellList, and the list is broadcast in another system message (except a system message of the SIB3).

The fifth list is NTN-ConfigNeighCellList={NTN-configNeighCell1, NTN-configNeighCell2, . . . , NTN-configNeighCell m . . . }, and the second indication list is {bitmap 1, . . . , bitmap i, . . . }, where bitmap i=0000 . . . 1(m^{th})000 . . . represents that satellite assistance information for an i^{th} cell is NTN-configNeighCell m, the i^{th} cell is an i^{th} element in the eleventh list, the eleventh list may be, for example, an InterFreqCarrierFreqList in a SIB4 or a list that is of information about an inter-frequency neighboring cell and that is at least partially the same as the InterFreqCarrierFreqList, and the list is broadcast in another system message (except a system message of the SIB4).

For example, the fifth list is NTN-ConfigNeighCellList={NTN-configNeighCell1, NTN-configNeighCell2, . . . , NTN-configNeighCell m . . . }, the first indication list is {2, 4, 1, . . . } and represents that satellite assistance information for a 1^{st} cell in the tenth list is NTN-configNeighCell 2, and the i^{th} cell is an i^{th} element in the tenth list.

The fifth list is NTN-ConfigNeighCellList={NTN-configNeighCell1, NTN-configNeighCell2, . . . , NTN-configNeighCell m . . . }, the second indication list is {2, 4, 1 . . . } and represents that satellite assistance information for a 1^{st} cell in the eleventh list is NTN-configNeighCell 2, and the i^{th} cell is an i^{th} element in the eleventh list.

Another implementation for (A3.2):

An i^{th} element in the first indication list and an i^{th} element in the tenth list may be in a same field, to indicate that satellite assistance information for a cell corresponding to the i^{th} element in the tenth list is indicated by the i^{th} element (index or bitmap) in the first indication list, in other words, in a case that the PCI of the target cell is in the i^{th} element in the tenth list, the satellite assistance information for the target cell is indicated by the i^{th} element in the first indication list. For example, in a case that the i^{th} element indicates a bitmap of 0100 . . . or an index of 2, it indicates that the satellite assistance information for the target cell is a 2^{nd} element in the fifth list.

An i^{th} element in the first indication list and an i^{th} element in the eleventh list may be in a same field, to indicate that satellite assistance information for a cell corresponding to the i^{th} element in the eleventh list is indicated by the i^{th} element (index or bitmap) in the first indication list, in other words, in a case that the PCI of the target cell is in the i^{th} element in the eleventh list, the satellite assistance information for the target cell is indicated by the i^{th} element in the first indication list. For example, in a case that the i^{th} element indicates a bitmap of 0100 . . . or an index of 2, it indicates that the satellite assistance information for the target cell is a 2^{nd} element in the fifth list.

For example, the tenth list may be an IntraFreqNeighCellList in a SIB3 or a list that is of information about an intra-frequency neighboring cell and that is at least partially the same as the IntraFreqNeighCellList, and the list is broadcast in another system message (except a system message of the SIB3).

For example, the eleventh list may be an InterFreqCarrierFreqList in a SIB4 or a list that is of information about an inter-frequency neighboring cell and that is at least partially the same as the InterFreqCarrierFreqList, and the list is broadcast in another system message (except a system message of the SIB4).

(A3.3) The terminal determines the satellite assistance information for the target cell according to the fifth list, a thirteenth list, and a third indication list, where the thirteenth list includes information about at least one neighboring cell, the third indication list includes an index or a bitmap corresponding to the at least one neighboring cell, an i^{th} index or bitmap in the third indication list indicates that i^{th} information in the thirteenth list corresponds to m^{th} satellite assistance information in the fifth list, and m corresponds to indicated content of the i^{th} index or bitmap.

In this embodiment of this application, an explicit association manner is provided to determine the satellite assistance information for the target cell. Specifically, for the intra-frequency neighboring cell and the inter-frequency neighboring cell, one index or bitmap indication list, that is, the third indication list, is used, and the third indication list indicates the satellite assistance information corresponding to each neighboring cell in the fifth list for each neighboring cell. m may include one or more values indicating that the third indication list may indicate one or more pieces of satellite assistance information corresponding to each neighboring cell in the fifth list for each neighboring cell.

For example, in an implementation, the fifth list is NTN-ConfigNeighCellList={NTN-configNeighCell1, NTN-configNeighCell2, . . . , NTN-configNeighCell m . . . }, the third indication list is {2, 4, 1, . . . } or {bitmap 1, . . . , bitmap i, . . . }, where bitmap 1=0100 . . . represents that satellite assistance information for a 1^{st} cell in the thirteenth list is NTN-configNeighCell 2, and the i^{th} cell is an i^{th} element in the thirteenth list.

In another implementation, an i^{th} element in the third indication list and an i^{th} element in the thirteenth list may be in a same field, to indicate that satellite assistance information for a cell corresponding to the i^{th} element in the thirteenth list is indicated by the i^{th} element (index or bitmap) in the third indication list, in other words, in a case that the PCI of the target cell is in the i^{th} element in the thirteenth list, the satellite assistance information for the target cell is indicated by the i^{th} element in the third indication list. For example, in a case that the i^{th} element indicates a bitmap of 0100 . . . or an index of 2, it indicates that the satellite assistance information for the target cell is a 2^{nd} element in the fifth list.

For example, the thirteenth list may be a list consisting of an IntraFreqNeighCellList in a SIB3 and an InterFreqCarrierFreqListinterFreq-NTN-ConfigNeighCellList in a SIB4, or may be a list consisting of first information and second information. The first information is information that is about an intra-frequency neighboring cell and that is at least partially the same as the IntraFreqNeighCellList in the SIB3. The second information is information that is about an inter-frequency neighboring cell and that is at least partially the same as the InterFreqCarrierFreqList in the SIB4.

(A3.4) The terminal determines the satellite assistance information for the target cell according to the fifth list, a thirteenth list, and a fourth indication list, where the thirteenth list includes information about at least one neighboring cell, the fourth indication list includes an index or a bitmap corresponding to satellite assistance information for the at least one neighboring cell, an i^{th} index or bitmap in the fourth indication list indicates that i^{th} satellite assistance information in the fifth list corresponds to m^{th} information in the thirteenth list, and m corresponds to indicated content of the i^{th} index or bitmap.

In this embodiment of this application, an explicit association manner is provided to determine the satellite assistance information for the target cell. Specifically, for the satellite assistance information for the intra-frequency neighboring cell and the satellite assistance information for the inter-frequency neighboring cell, one index or bitmap indication list, that is, the fourth indication list, is used (different from (A3.3), the index or the bitmap herein indicates which cells are associated with satellite assistance information, but (A3.3) is that the index or the bitmap indicates which pieces of (or which piece of) satellite assistance information are associated with a cell), and the fourth indication list indicates a neighboring cell corresponding to each piece of satellite assistance information in the thirteenth list for each piece of satellite assistance information in the fifth list. m may include one or more values indicating that the fourth indication list may indicate one or more neighboring cells corresponding to each piece of satellite assistance information in the thirteenth list for each piece of satellite assistance information in the fifth list, or may be understood as that one or more indicated neighboring cells use same satellite assistance information.

For example, in an implementation, the fifth list is NTN-ConfigNeighCellList={NTN-configNeighCell1, NTN-configNeighCell2, . . . , NTN-configNeighCell m . . . }, the fourth indication list is {bitmap 1, . . . , bitmap m, . . . }, where bitmap 1=10010 . . . , or the fourth indication list is {{1, 4}, {2}, . . . } and represents that satellite assistance information for a 1st cell and a 4^{th} cell in the thirteenth list is NTN-configNeighCell 1, and the i^{th} cell is an i^{th} element in the thirteenth list.

In another implementation, an i^{th} element in the fourth indication list and an i^{th} element in the thirteenth list may be in a same field, to indicate that a cell corresponding to the i^{th} element in the fifth list is indicated by the i^{th} element (index or bitmap) in the fourth indication list. For example, in a case that the i^{th} element indicates a bitmap of 1004 . . . or an index of {1, 4}, it indicates that a cell associated with the i^{th} satellite assistance information in the fifth list is a 1^{st} element and a 4^{th} element in the thirteenth list, that is, satellite assistance information for a 1^{st} cell and satellite assistance information for a 4^{th} cell in the thirteenth list are the i^{th} element in the fifth list.

For example, the thirteenth list may be a list consisting of an IntraFreqNeighCellList in a SIB3 and an InterFreqCarrierFreqListinterFreq-NTN-ConfigNeighCellList in a SIB4, or may be a list consisting of first information and second information. The first information is information that is about an intra-frequency neighboring cell and that is at least partially the same as the IntraFreqNeighCellList in the SIB3. The second information is information that is about an inter-frequency neighboring cell and that is at least partially the same as the InterFreqCarrierFreqList in the SIB4.

(A3.5) The terminal determines the satellite assistance information for the target cell according to the fifth list, a thirteenth list, and a first cell list, where the thirteenth list includes information about at least one neighboring cell, the first cell list includes cell information corresponding to the satellite assistance information for the at least one neighboring cell, the cell information includes at least one of the following: a physical cell identifier PCI and a frequency, the first cell list indicates that i^{th} satellite assistance information in the fifth list corresponds to m^{th} information in the thirteenth list, and m corresponds to indicated content of the first cell list.

In this embodiment of this application, an explicit association manner is provided to determine the satellite assistance information for the target cell. Specifically, the first cell list directly indicates the cell information such as the PCI and/or the frequency.

In an implementation, the fifth list is NTN-ConfigNeighCellList={NTN-configNeighCell1, NTN-configNeighCell2, . . . , NTN-configNeighCell m . . . }, and the first cell list is {{PCI 1, PCI 4}, {PCI 3} . . . } and represents that satellite assistance information for cells with physical cell identifiers of PCI 1 and PCI 4 is NTN-configNeighCell1.

In another implementation, an i^{th} element in the first cell list and an i^{th} element in the fifth list may be in a same field, to indicate that a cell corresponding to the i^{th} element in the fifth list is indicated by the i^{th} element in the first cell list. For example, in a case that the i^{th} element is {PCI 1, PCI 4}, it indicates that cells associated with the i^{th} satellite assistance information in the fifth list are cells with PCI values of PCI 1 and PCI 4, that is, satellite assistance information for the cells with the PCI values of PCI 1 and PCI 4 in the thirteenth list is the i^{th} element in the fifth list.

i, j, m, and n are all positive integers.

In a possible implementation, (A4) that the terminal determines the satellite assistance information for the target cell according to a sixth list includes any one of the following:

(A4.1) The terminal determines the satellite assistance information for the target cell according to the sixth list and a fourteenth list, where the fourteenth list includes information about the serving cell and information about at least one neighboring cell, and i^{th} satellite assistance information in the satellite assistance information for the at least one neighboring cell in the sixth list corresponds to i^{th} information in the information about the at least one neighboring cell in the fourteenth list.

In this embodiment of this application, an implicit association manner is provided to determine the satellite assistance information for the target cell. Specifically, in the sixth list, a 1^{st} element may be set as the satellite assistance information for the serving cell by default. It may be understood that it is applicable for setting the last element as the satellite assistance information for the serving cell or setting any of middle elements as the satellite assistance information for the serving cell. In this application, for ease of description of the solution, the 1^{st} element is set as the satellite assistance information for the serving cell by default uniformly. Similarly, a 1^{st} element is set as the information about the serving cell in the fourteenth list.

In this way, starting from the 1^{st} element in the sixth list and the 1^{st} element in the fourteenth list, the satellite assistance information corresponding to all the neighboring cells can be determined in one-to-one correspondence in an order agreed in a protocol.

(A4.2) The terminal determines the satellite assistance information for the target cell according to the sixth list, a fourteenth list, and a fifth indication list, where the fourteenth list includes information about the serving cell and information about at least one neighboring cell, the fifth indication list includes an index or a bitmap of the serving cell and an index or a bitmap corresponding to the at least one neighboring cell, the index or the bitmap corresponding to the serving cell in the fifth indication list indicates that the information about the serving cell in the fourteenth list corresponds to the satellite assistance information for the serving cell in the sixth list, an i^{th} index or bitmap in the index or the bitmap corresponding to the at least one neighboring cell in the fifth indication list indicates that i^{th} information in the information about the at least one neighboring cell in the fourteenth list corresponds to m^{th} satellite assistance information in the satellite assistance information for the at least one neighboring cell in the sixth list, and m corresponds to indicated content of the i^{th} index or bitmap.

In this embodiment of this application, an explicit association manner is provided to determine the satellite assistance information for the target cell. Specifically, in the sixth list, a 1^{st} element may be set as the satellite assistance information for the serving cell by default. Similarly, a 1^{st} element is set as the information about the serving cell in the fourteenth list. A 1^{st} index or bitmap in the fifth indication list is set to indicate the serving cell.

The fifth indication list indicates satellite assistance information corresponding to each neighboring cell in the sixth list for each neighboring cell. m may include one or more values indicating that the fifth indication list may indicate one or more pieces of satellite assistance information corresponding to each neighboring cell in the fifth list for each neighboring cell.

(A4.3) The terminal determines the satellite assistance information for the target cell according to the sixth list, a fourteenth list, and a sixth indication list, where the fourteenth list includes information about the serving cell and information about at least one neighboring cell, the sixth indication list includes an index or a bitmap corresponding to the satellite assistance information for the serving cell and an index or a bitmap corresponding to the satellite assistance information for the at least one neighboring cell, the index or the bitmap corresponding to the satellite assistance information for the serving cell in the sixth indication list indicates that the information about the serving cell in the fourteenth list corresponds to the satellite assistance information for the serving cell in the sixth list, an i^{th} index or bitmap in the index or the bitmap corresponding to the satellite assistance information for the at least one neighboring cell in the sixth indication list indicates that i^{th} satellite assistance information in the satellite assistance information for the at least one neighboring cell in the sixth list corresponds to m^{th} information in the information about the at least one neighboring cell in the fourteenth list, and m corresponds to indicated content of the i^{th} index or bitmap.

In this embodiment of this application, an explicit association manner is provided to determine the satellite assistance information for the target cell. Specifically, in the sixth list, a 1^{st} element may be set as the satellite assistance information for the serving cell by default. Similarly, a 1^{st} element is set as the information about the serving cell in the fourteenth list. A 1^{st} index or bitmap in the sixth indication list is set to indicate the serving cell.

The sixth indication list indicates a neighboring cell corresponding to each piece of satellite assistance information in the fourteenth list for each piece of satellite assistance information in the sixth list. m may include one or more values indicating that the sixth indication list may indicate one or more neighboring cells corresponding to each piece of satellite assistance information in the fourteenth list for each piece of satellite assistance information in the sixth list, or may be understood as that one or more indicated neighboring cells use same satellite assistance information.

(A4.4) The terminal determines the satellite assistance information for the target cell according to the sixth list, a fourteenth list, and a second cell list, where the fourteenth list includes information about the serving cell and information about at least one neighboring cell, the second cell list includes cell information corresponding to the satellite assistance information for the serving cell and cell information corresponding to the satellite assistance information for the at least one neighboring cell, the cell information includes at least one of the following: a PCI and a frequency, a PCI corresponding to the satellite assistance information for the serving cell in the second cell list indicates that the satellite assistance information for the serving cell in the sixth list corresponds to the information about the serving cell in the fourteenth list, an i^{th} PCI in the second cell list indicates that i^{th} satellite assistance information in the satellite assistance information for the at least one neighboring cell in the sixth list corresponds to m^{th} information in the information about the at least one neighboring cell in the fourteenth list, and m corresponds to indicated content of the i^{th} PCI.

In this embodiment of this application, an explicit association manner is provided to determine the satellite assistance information for the target cell. Specifically, the second cell list directly indicates the cell information such as the PCI and/or the frequency. m may include one or more values indicating that the second cell list may indicate one or more neighboring cells corresponding to each piece of satellite assistance information in the fourteenth list for each piece of satellite assistance information in the sixth list, or may be understood as that one or more indicated neighboring cells use same satellite assistance information.

Both i and m are positive integers.

In the foregoing embodiment, the 1^{st} element in the fourteenth list is the information about the serving cell, and another element is an element in the thirteenth list.

In a possible implementation, (B1) that the terminal determines the satellite assistance information for the target cell or the target frequency according to a seventh list and an eighth list includes any one of the following:

(B1.1) The terminal determines the satellite assistance information for the target cell or the target frequency according to the seventh list, the eighth list, and a fifteenth list, where the fifteenth list includes information about at least one neighboring frequency, i^{th} satellite assistance information in the seventh list corresponds to i^{th} information in the fifteenth list, and information about an i^{th} neighboring frequency in the fifteenth list corresponds to i^{th} first information in the eighth list.

In this embodiment of this application, an implicit association manner is provided to determine the satellite assistance information for the target cell or the target frequency. Specifically, the seventh list consists of satellite assistance information for all neighboring frequencies, and the satellite assistance information for the neighboring frequency in the seventh list corresponds one-to-one to the information about the neighboring frequency in the fifteenth list in an order agreed in a protocol, so that satellite assistance information corresponding to each neighboring frequency can be determined. In addition, the satellite assistance information for the neighboring frequency in the seventh list also corresponds to at least one neighboring cell corresponding to each neighboring frequency indicated in the eighth list, which is equivalent to determining that one or more neighboring cells corresponding to each neighboring frequency use same satellite assistance information.

(B1.2) The terminal determines the satellite assistance information for the target cell or the target frequency according to the seventh list, the eighth list, a fifteenth list, and a seventh indication list, where the fifteenth list includes information about at least one neighboring frequency, the seventh indication list includes an index or a bitmap corresponding to the at least one neighboring frequency, an i^{th} index or bitmap in the seventh indication list indicates that information about an it neighboring frequency in the fifteenth list corresponds to m^{th} satellite assistance information in the seventh list, m corresponds to indicated content of the i^{th} index or bitmap, and the information about the i^{th} neighboring frequency in the fifteenth list corresponds to i^{th} first information in the eighth list.

In this embodiment of this application, an explicit association manner is provided to determine the satellite assistance information for the target cell or the target frequency. Specifically, the seventh indication list indicates the satellite assistance information corresponding to each neighboring frequency in the seventh list for each neighboring frequency in the fifteenth list. m may include one or more values indicating that the seventh indication list may indicate one or more pieces of satellite assistance information corresponding to each neighboring frequency in the seventh list for each neighboring frequency in the fifteenth list. In addition, the satellite assistance information for the neighboring frequency in the seventh list also corresponds to at least one neighboring cell corresponding to each neighboring frequency indicated in the eighth list, which is equivalent to determining that one or more neighboring cells corresponding to each neighboring frequency use same satellite assistance information.

(B1.3) The terminal determines the satellite assistance information for the target cell or the target frequency according to the seventh list, the eighth list, a fifteenth list, and an eighth indication list, where the fifteenth list includes information about at least one neighboring frequency, the eighth indication list includes an index or a bitmap corresponding to the satellite assistance information for the at least one neighboring frequency, an i^{th} index or bitmap in the eighth indication list indicates that i^{th} satellite assistance information in the seventh list corresponds to information about an m^{th} neighboring frequency in the fifteenth list, m corresponds to indicated content of the i^{th} index or bitmap, and information about an i^{th} neighboring frequency in the fifteenth list corresponds to i^{th} first information in the eighth list.

In this embodiment of this application, an explicit association manner is provided to determine the satellite assistance information for the target cell or the target frequency. Specifically, the eighth indication list indicates a neighboring frequency corresponding to each piece of satellite assistance information in the fifteenth list for each piece of satellite assistance information in the seventh list. m may include one or more values indicating that the eighth indication list may indicate one or more neighboring frequencies corresponding to each piece of satellite assistance information in the fifteenth list for each piece of satellite assistance information in the seventh list, or may be understood as that one or more indicated neighboring frequencies use same satellite assistance information. In addition, the satellite assistance information for the neighboring frequency in the seventh list also corresponds to at least one neighboring cell corresponding to each neighboring frequency indicated in the eighth list, which is equivalent to determining that one or more neighboring cells corresponding to each neighboring frequency use same satellite assistance information.

Both i and m are positive integers.

In a possible implementation, (B2) that the terminal determines the satellite assistance information for the target frequency or the target frequency according to an eighth list and a ninth list includes any one of the following:

(B2.1) The terminal determines the satellite assistance information for the target cell or the target frequency according to the eighth list, the ninth list, and a sixteenth list, where the sixteenth list includes information about the serving frequency and information about at least one neighboring frequency, i^{th} satellite assistance information in the satellite assistance information for the at least one neighboring frequency in the ninth list corresponds to i^{th} information in the information about the at least one neighboring frequency in the sixteenth list, and the it information in the information about the at least one neighboring frequency in the sixteenth list corresponds to i^{th} first information in the eighth list.

In this embodiment of this application, an implicit association manner is provided to determine the satellite assistance information for the target cell or the target frequency. Specifically, in the ninth list, a 1^{st} element may be set as the satellite assistance information for the serving frequency by default. Similarly, a 1^{st} element is set as the information about the serving frequency in the sixteenth list.

In this way, starting from the 1^{st} element in the ninth list and the 1^{st} element in the sixteenth list, the satellite assistance information corresponding to all the neighboring frequencies can be determined in one-to-one correspondence in an order agreed in a protocol. In addition, the satellite assistance information for the neighboring frequency in the ninth list also corresponds to at least one neighboring cell corresponding to each neighboring frequency indicated in the eighth list, which is equivalent to determining that one or more neighboring cells corresponding to each neighboring frequency use same satellite assistance information.

(B2.2) The terminal determines the satellite assistance information for the target cell or the target frequency according to the eighth list, the ninth list, a sixteenth list, and a ninth indication list, where the sixteenth list includes information about the serving frequency and information about at least one neighboring frequency, the ninth indication list includes an index or a bitmap corresponding to the serving frequency and an index or a bitmap corresponding to the at least one neighboring frequency, the index or the bitmap corresponding to the serving frequency in the ninth indication list indicates that the information about the serving frequency in the sixteenth list corresponds to the satellite assistance information for the serving frequency in the ninth list, an i^{th} index or bitmap in the index or the bitmap corresponding to the at least one neighboring frequency in the ninth indication list indicates that i^{th} information in the information about the at least one neighboring frequency in the sixteenth list corresponds to m^{th} satellite assistance information in the satellite assistance information for the at least one neighboring frequency in the ninth list, m corresponds to indicated content of the i^{th} index or bitmap, and the i^{th} information in the information about the at least one neighboring frequency in the sixteenth list corresponds to i^{th} first information in the eighth list.

In this embodiment of this application, an explicit association manner is provided to determine the satellite assistance information for the target cell or the target frequency. Specifically, in the ninth list, a 1^{st} element may be set as the satellite assistance information for the serving frequency by default. Similarly, a 1^{st} element is set as the information about the serving frequency in the sixteenth list. A 1^{st} index or bitmap in the ninth indication list is set to indicate the serving frequency.

The ninth indication list indicates satellite assistance information corresponding to each neighboring frequency in the ninth list for each neighboring frequency. m may include one or more values indicating that the ninth indication list may indicate one or more pieces of satellite assistance information corresponding to each neighboring frequency in the ninth list for each neighboring frequency.

(B2.3) The terminal determines the satellite assistance information for the target cell or the target frequency according to the eighth list, the ninth list, a sixteenth list, and a tenth indication list, where the sixteenth list includes information about the serving frequency and information about at least one neighboring frequency, the tenth indication list includes an index or a bitmap corresponding to the satellite assistance information for the serving frequency, and an index or a bitmap corresponding to the satellite assistance information for the at least one neighboring frequency, or a first frequency list, the index or the bitmap corresponding to the satellite assistance information for the serving frequency, or the first frequency list in the tenth indication list indicates that the information about the serving frequency in the sixteenth list corresponds to the satellite assistance information for the serving frequency in the ninth list, an i^{th} index or bitmap in the index or the bitmap corresponding to the satellite assistance information for the at least one neighboring frequency, or first frequency list in the tenth indication list indicates that i^{th} satellite assistance information in the satellite assistance information for the at least one neighboring frequency in the ninth list corresponds to m^{th} information in the information about the at least one neighboring frequency in the sixteenth list, m corresponds to indicated content of the i^{th} index or bitmap, or the first frequency list, the first frequency list includes frequency information of a cell, and i^{th} information in the information about the at least one neighboring frequency in the sixteenth list corresponds to i^{th} first information in the eighth list.

In this embodiment of this application, an explicit association manner is provided to determine the satellite assistance information for the target cell or the target frequency. Specifically, in the ninth list, a 1^{st} element may be set as the satellite assistance information for the serving frequency by default. Similarly, a 1^{st} element is set as the information about the serving frequency in the sixteenth list. A 1^{st} index or bitmap in the ninth indication list is set to indicate the serving frequency.

The ninth indication list indicates a neighboring frequency corresponding to satellite assistance information in the sixteenth list for the satellite assistance information in the ninth list. m may include one or more values indicating that the ninth indication list may indicate one or more neighboring frequencies corresponding to satellite assistance information in the sixteenth list for the satellite assistance information in the ninth list, or may be understood as that one or more indicated neighboring frequencies use same satellite assistance information.

Both i and m are positive integers.

It should be noted that the above-mentioned lists (the first list to the sixteenth list, the first indication list to the ninth indication list, and the like) may be carried in a SIB broadcast by the network side, and the terminal may obtain the foregoing lists together with the satellite assistance information.

In a possible implementation, in a case that the first message and the second message are a same message, that a terminal obtains a first message and a second message includes: The terminal obtains a first target SIB.

For example, all satellite assistance information may be broadcast through a SIBX (that is, the first target SIB).

In a possible implementation, in a case that the first message and the second message are different messages, that a terminal obtains a first message and a second message includes one or more of the following:

(1) The terminal obtains a part of the first message through the first target SIB, and the terminal obtains the other part of the first message through a second target SIB.

For example, a part of satellite assistance information (such as intra-frequency satellite assistance information) is broadcast through a SIBX, and the other part of the satellite assistance information (such as inter-frequency satellite assistance information) is broadcast through a SIBY (that is, the second target SIB), where the SIBY is a new SIB introduced for broadcasting satellite assistance information for a neighboring cell.

(2) The terminal obtains a part of satellite assistance information for an intra-frequency neighboring cell through a first SIB, the terminal obtains the other part of the satellite assistance information for the intra-frequency neighboring cell through a first target SIB, the terminal obtains a part of satellite assistance information for an inter-frequency neighboring cell through a second SIB, and the terminal obtains the other part of the satellite assistance information for the inter-frequency neighboring cell through a first target SIB.

For example, a part of satellite assistance information for an intra-frequency neighboring cell is broadcast through a SIB3 (that is, the first SIB) and the other part is broadcast through a SIBX. A part of satellite assistance information for an inter-frequency neighboring cell is broadcast through a SIB4 (that is, the second SIB) and the other part is broadcast through a SIBX.

In a possible implementation, the method further includes:

(1) The terminal re-obtains the first SIB, the second SIB, the first target SIB, and/or the second target SIB in a case that the terminal considers that the first SIB and/or the second SIB are/is invalid.

(2) The terminal re-obtains the first SIB, the second SIB, the first target SIB, and/or the second target SIB in a case that the terminal considers that the first target SIB and/or the second target SIB are/is invalid.

The terminal may determine validity of the SIB by using a method in related technologies, which may, for example, be detected and completed by the terminal independently, or completed by providing some configuration information by the network side to assist the terminal. This is not limited in the embodiments of this application.

The satellite assistance information obtaining method provided in the embodiments of this application may be performed by a satellite assistance information obtaining apparatus. In the embodiments of this application, an example in which the satellite assistance information obtaining apparatus performs the satellite assistance information obtaining method is used to describe the satellite assistance information obtaining apparatus provided in the embodiments of this application.

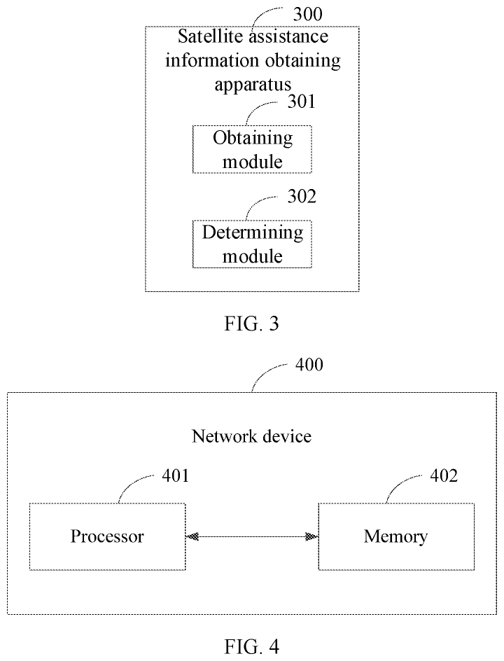

Refer to FIG. 3. A satellite assistance information obtaining apparatus 300 provided in an embodiment of this application includes:
an obtaining module 301, configured to obtain a first message and a second message by a terminal, where the first message includes at least one piece of satellite assistance information, and the second message includes satellite assistance information for a serving cell; and
a determining module 302, configured to determine satellite assistance information for a target cell or a target frequency according to the first message and/or the second message by the terminal, where the target cell is a neighboring cell of the serving cell, the target frequency is a neighboring frequency of a serving frequency, and the serving frequency is a frequency of the serving cell, where
the satellite assistance information in the first message is associated with at least one cell, or the satellite assistance information in the first message is associated with at least one frequency.

In some embodiments, in a case that the satellite assistance information in the first message is associated with the at least one cell, the determining module is configured to perform any one of the following:
determining, by the terminal, the satellite assistance information for the target cell according to a first list or a second list, where the first list includes first satellite assistance information, the first satellite assistance information includes satellite assistance information for at least one intra-frequency neighboring cell, the second list includes second satellite assistance information, the second satellite assistance information includes satellite assistance information for at least one inter-frequency neighboring cell, a frequency of the intra-frequency neighboring cell is the same as the serving frequency, and a frequency of the inter-frequency neighboring cell is different from the serving frequency;
determining, by the terminal, the satellite assistance information for the target cell according to a third list or a fourth list, where the third list includes first satellite assistance information, the first satellite assistance information includes satellite assistance information for at least one intra-frequency neighboring cell, the fourth list includes third satellite assistance information, the third satellite assistance information includes satellite assistance information for at least one neighboring cell, a frequency of the at least one neighboring cell is a first frequency, and the first frequency is different from the serving frequency;
determining, by the terminal, the satellite assistance information for the target cell according to a fifth list, where the fifth list includes fourth satellite assistance information, and the fourth satellite assistance information includes satellite assistance information for at least one neighboring cell; or
determining, by the terminal, the satellite assistance information for the target cell according to a sixth list, where the sixth list includes fifth satellite assistance information, and the fifth satellite assistance information includes the satellite assistance information for the serving cell and satellite assistance information for at least one neighboring cell.

In some embodiments, in a case that the satellite assistance information in the first message is associated with the at least one frequency, the determining module is configured to perform any one of the following:
determining, by the terminal, the satellite assistance information for the target cell or the target frequency according to a seventh list and an eighth list, where the seventh list includes sixth satellite assistance information, the sixth satellite assistance information includes satellite assistance information for at least one neighboring frequency, the neighboring frequency is different from the serving frequency, the eighth list includes at least one piece of first information, and the first information indicates at least one neighboring cell corresponding to each of the at least one neighboring frequency; or
determining, by the terminal, the satellite assistance information for the target cell or the target frequency according to an eighth list and a ninth list, where the ninth list includes seventh satellite assistance information, the seventh satellite assistance information includes satellite assistance information for the serving frequency and satellite assistance information for at least one neighboring frequency, the neighboring frequency is different from the serving frequency, the eighth list includes at least one piece of first information, and the first information indicates at least one neighboring cell corresponding to each of the at least one neighboring frequency.

In some embodiments, the determining module is configured to perform any one of the following:
in a case that the target cell is an intra-frequency neighboring cell, determining, by the terminal, the satellite assistance information for the target cell according to the first list and a tenth list, where the tenth list includes information about at least one intra-frequency neighboring cell, and i^{th} satellite assistance information in the first list corresponds to i^{th} information in the tenth list; or
in a case that the target cell is an inter-frequency neighboring cell, determining, by the terminal, the satellite assistance information for the target cell according to the second list and an eleventh list, where the eleventh list includes information about at least one inter-frequency neighboring cell and information about a frequency related to the at least one inter-frequency neighboring cell, and j^{th} satellite assistance information in the second list corresponds to j^{th} information in the eleventh list, where
both i and j are positive integers.

In some embodiments, the determining module is configured to perform any one of the following:
in a case that the target cell is an intra-frequency neighboring cell, determining, by the terminal, the satellite assistance information for the target cell according to the third list and a tenth list, where the tenth list includes information about at least one intra-frequency neighboring cell, and i^{th} satellite assistance information in the third list corresponds to i^{th} information in the tenth list; or
in a case that a frequency of the target cell is the first frequency, determining, by the terminal, the satellite assistance information for the target cell according to the fourth list and a twelfth list, where the twelfth list includes information about the at least one neighboring cell corresponding to the first frequency, and j^{th} satellite assistance information in the fourth list corresponds to j^{th} information in the twelfth list, where
both i and j are positive integers.

In some embodiments, the determining module is configured to perform any one of the following:
determining, by the terminal, the satellite assistance information for the target cell according to the fifth list and a thirteenth list, where the thirteenth list includes information about at least one neighboring cell, and i^{th} satellite assistance information in the fifth list corresponds to i^{th} information in the thirteenth list;
determining, by the terminal, the satellite assistance information for the target cell according to the fifth list, a first indication list, and a second indication list, where the first indication list includes an index (index) or a bitmap (bitmap) corresponding to at least one intra-frequency neighboring cell, the second indication list includes an index or a bitmap corresponding to at least one inter-frequency neighboring cell, an i^{th} index or bitmap in the first indication list indicates that an i^{th} intra-frequency neighboring cell corresponds to m^{th} satellite assistance information in the fifth list, m corresponds to indicated content of the i^{th} index or bitmap, a j^{th} index or bitmap in the second indication list indicates that a j^{th} inter-frequency neighboring cell corresponds to n^{th} satellite assistance information in the fifth list, and n corresponds to indicated content of the j^{th} index or bitmap;
determining, by the terminal, the satellite assistance information for the target cell according to the fifth list, a thirteenth list, and a third indication list, where the thirteenth list includes information about at least one neighboring cell, the third indication list includes an index or a bitmap corresponding to the at least one neighboring cell, an i^{th} index or bitmap in the third indication list indicates that i^{th} information in the thirteenth list corresponds to m^{th} satellite assistance information in the fifth list, and m corresponds to indicated content of the i^{th} index or bitmap;
determining, by the terminal, the satellite assistance information for the target cell according to the fifth list, a thirteenth list, and a fourth indication list, where the thirteenth list includes information about at least one neighboring cell, the fourth indication list includes an index or a bitmap corresponding to satellite assistance information for the at least one neighboring cell, an i^{th} index or bitmap in the fourth indication list indicates that i^{th} satellite assistance information in the fifth list corresponds to mi information in the thirteenth list, and m corresponds to indicated content of the i^{th} index or bitmap; or
determining, by the terminal, the satellite assistance information for the target cell according to the fifth list, a thirteenth list, and a first cell list, where the thirteenth list includes information about at least one neighboring cell, the first cell list includes cell information corresponding to the satellite assistance information for the at least one neighboring cell, the cell information includes at least one of the following: a physical cell identifier PCI and a frequency, the first cell list indicates that i^{th} satellite assistance information in the fifth list corresponds to m^{th} information in the thirteenth list, and m corresponds to indicated content of the first cell list, where
i, j, m, and n are all positive integers.

In some embodiments, the determining module is configured to perform any one of the following:
determining, by the terminal, the satellite assistance information for the target cell according to the sixth list and a fourteenth list, where the fourteenth list includes information about the serving cell and information about at least one neighboring cell, and i^{th} satellite assistance information in the satellite assistance information for the at least one neighboring cell in the sixth list corresponds to i^{th} information in the information about the at least one neighboring cell in the fourteenth list;
determining, by the terminal, the satellite assistance information for the target cell according to the sixth list, a fourteenth list, and a fifth indication list, where the fourteenth list includes information about the serving cell and information about at least one neighboring cell, the fifth indication list includes an index or a bitmap of the serving cell and an index or a bitmap corresponding to the at least one neighboring cell, the index or the bitmap corresponding to the serving cell in the fifth indication list indicates that the information about the serving cell in the fourteenth list corresponds to the satellite assistance information for the serving cell in the sixth list, an i^{th} index or bitmap in the index or the bitmap corresponding to the at least one neighboring cell in the fifth indication list indicates that i^{th} information in the information about the at least one neighboring cell in the fourteenth list corresponds to m^{th} satellite assistance information in the satellite assistance information for the at least one neighboring cell in the sixth list, and m corresponds to indicated content of the i^{th} index or bitmap;
determining, by the terminal, the satellite assistance information for the target cell according to the sixth list, a fourteenth list, and a sixth indication list, where the fourteenth list includes information about the serving cell and information about at least one neighboring cell, the sixth indication list includes an index or a bitmap corresponding to the satellite assistance information for the serving cell and an index or a bitmap corresponding to the satellite assistance information for the at least one neighboring cell, the index or the bitmap corresponding to the satellite assistance information for the serving cell in the sixth indication list indicates that the information about the serving cell in the fourteenth list corresponds to the satellite assistance information for the serving cell in the sixth list, an i^{th} index or bitmap in the index or the bitmap corresponding to the satellite assistance information for the at least one neighboring cell in the sixth indication list indicates that i^{th} satellite assistance information in the satellite assistance information for the at least one neighboring cell in the sixth list corresponds to m^{th} information in the information about the at least one neighboring cell in the fourteenth list, and m corresponds to indicated content of the i^{th} index or bitmap; or
determining, by the terminal, the satellite assistance information for the target cell according to the sixth list, a fourteenth list, and a second cell list, where the fourteenth list includes information about the serving cell and information about at least one neighboring cell, the second cell list includes cell information corresponding to the satellite assistance information for the serving cell and cell information corresponding to the satellite assistance information for the at least one neighboring cell, the cell information includes at least one of the following: a PCI and a frequency, a PCI corresponding to the satellite assistance information for the serving cell in the second cell list indicates that the satellite assistance information for the serving cell in the sixth list corresponds to the information about the serving cell in the fourteenth list, an i^{th} PCI in the second cell list indicates that i^{th} satellite assistance information in the satellite assistance information for the at least one neighboring cell in the sixth list corresponds to mi information in the information about the at least one neighboring cell in the fourteenth list, and m corresponds to indicated content of the i^{th} PCI, where both i and m are positive integers.

In some embodiments, the determining module is configured to perform any one of the following:
determining, by the terminal, the satellite assistance information for the target cell or the target frequency according to the seventh list, the eighth list, and a fifteenth list, where the fifteenth list includes information about at least one neighboring frequency, i^{th} satellite assistance information in the seventh list corresponds to i^{th} information in the fifteenth list, and information about an i^{th} neighboring frequency in the fifteenth list corresponds to i^{th} first information in the eighth list;
determining, by the terminal, the satellite assistance information for the target cell or the target frequency according to the seventh list, the eighth list, a fifteenth list, and a seventh indication list, where the fifteenth list includes information about at least one neighboring frequency, the seventh indication list includes an index or a bitmap corresponding to the at least one neighboring frequency, an i^{th} index or bitmap in the seventh indication list indicates that information about an i^{th} neighboring frequency in the fifteenth list corresponds to m^{th} satellite assistance information in the seventh list, m corresponds to indicated content of the i^{th} index or bitmap, and the information about the i^{th} neighboring frequency in the fifteenth list corresponds to i^{th} first information in the eighth list; or
determining, by the terminal, the satellite assistance information for the target cell or the target frequency according to the seventh list, the eighth list, a fifteenth list, and an eighth indication list, where the fifteenth list includes information about at least one neighboring frequency, the eighth indication list includes an index or a bitmap corresponding to the satellite assistance information for the at least one neighboring frequency, an i^{th} index or bitmap in the eighth indication list indicates that i^{th} satellite assistance information in the seventh list corresponds to information about an m^{th} neighboring frequency in the fifteenth list, m corresponds to indicated content of the i^{th} index or bitmap, and information about an i^{th} neighboring frequency in the fifteenth list corresponds to i^{th} first information in the eighth list, where
both i and m are positive integers.

In some embodiments, the determining module is configured to perform any one of the following:
determining, by the terminal, the satellite assistance information for the target cell or the target frequency according to the eighth list, the ninth list, and a sixteenth list, where the sixteenth list includes information about the serving frequency and information about at least one neighboring frequency, i^{th} satellite assistance information in the satellite assistance information for the at least one neighboring frequency in the ninth list corresponds to i^{th} information in the information about the at least one neighboring frequency in the sixteenth list, and the i^{th} information in the information about the at least one neighboring frequency in the sixteenth list corresponds to i^{th} first information in the eighth list;
determining, by the terminal, the satellite assistance information for the target cell or the target frequency according to the eighth list, the ninth list, a sixteenth list, and a ninth indication list, where the sixteenth list includes information about the serving frequency and information about at least one neighboring frequency, the ninth indication list includes an index or a bitmap corresponding to the serving frequency and an index or a bitmap corresponding to the at least one neighboring frequency, the index or the bitmap corresponding to the serving frequency in the ninth indication list indicates that the information about the serving frequency in the sixteenth list corresponds to the satellite assistance information for the serving frequency in the ninth list, an i^{th} index or bitmap in the index or the bitmap corresponding to the at least one neighboring frequency in the ninth indication list indicates that i^{th} information in the information about the at least one neighboring frequency in the sixteenth list corresponds to m^{th} satellite assistance information in the satellite assistance information for the at least one neighboring frequency in the ninth list, m corresponds to indicated content of the i^{th} index or bitmap, and the i^{th} information in the information about the at least one neighboring frequency in the sixteenth list corresponds to i^{th} first information in the eighth list; or
determining, by the terminal, the satellite assistance information for the target cell or the target frequency according to the eighth list, the ninth list, a sixteenth list, and a tenth indication list, where the sixteenth list includes information about the serving frequency and information about at least one neighboring frequency, the tenth indication list includes an index or a bitmap corresponding to the satellite assistance information for the serving frequency, and an index or a bitmap corresponding to the satellite assistance information for the at least one neighboring frequency, or a first frequency list, the index or the bitmap corresponding to the satellite assistance information for the serving frequency, or the first frequency list in the tenth indication list indicates that the information about the serving frequency in the sixteenth list corresponds to the satellite assistance information for the serving frequency in the ninth list, an i^{th} index or bitmap in the index or the bitmap corresponding to the satellite assistance information for the at least one neighboring frequency, or first frequency list in the tenth indication list indicates that i^{th} satellite assistance information in the satellite assistance information for the at least one neighboring frequency in the ninth list corresponds to m^{th} information in the information about the at least one neighboring frequency in the sixteenth list, m corresponds to indicated content of the i^{th} index or bitmap, or the first frequency list, the first frequency list includes frequency information of a cell, and i^{th} information in the information about the at least one neighboring frequency in the sixteenth list corresponds to i^{th} first information in the eighth list, where
both i and m are positive integers.

In some embodiments, the first message and the second message are a same message, for example, may be a same system information block SIB.

In some embodiments, in a case that the first message and the second message are a same message, the obtaining module is configured to:
obtain a first target system information block SIB by the terminal; and in a case that the first message and the second message are different messages, the obtaining module is configured to perform one or more of the following:
obtaining, by the terminal, a part of the first message through the first target SIB, and obtaining, by the terminal, the other part of the first message through a second target SIB; and
obtaining, by the terminal, a part of satellite assistance information for an intra-frequency neighboring cell through a first SIB, obtaining, by the terminal, the other part of the satellite assistance information for the intra-frequency neighboring cell through a first target SIB, obtaining, by the terminal, a part of satellite assistance information for an inter-frequency neighboring cell through a second SIB, and obtaining, by the terminal, the other part of the satellite assistance information for the inter-frequency neighboring cell through a first target SIB.

In some embodiments, the obtaining module is further configured to:
re-obtain the first SIB, the second SIB, the first target SIB, and/or the second target SIB by the terminal in a case that the terminal considers that the first SIB and/or the second SIB are/is invalid; and
re-obtain the first SIB, the second SIB, the first target SIB, and/or the second target SIB by the terminal in a case that the terminal considers that the first target SIB and/or the second target SIB are/is invalid.

In some embodiments, the satellite assistance information includes one or more of the following:
ephemeris information;
a common timing advance TA parameter;
validity duration of uplink synchronization information;
cell service stop time;
a cell reference location;
epoch time;
polarization information for downlink transmission;
polarization information for uplink transmission;
a timing advance reporting indication;
a scheduling offset provided by a network side in a case that frame timing of a downlink is inconsistent with frame timing of an uplink on the network side; and
a scheduling offset for modifying a timing relationship in a non-terrestrial network NTN.

The satellite assistance information obtaining apparatus in this embodiment of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed types of the terminal. The another device may be a server, a network attached storage (Network Attached Storage, NAS), or the like. This is not specifically limited in this embodiment of this application.

The satellite assistance information obtaining apparatus provided in this embodiment of this application can implement the processes implemented in the method embodiment of FIG. 2 and achieve a same technical effect. To avoid repetition, details are not described herein again.

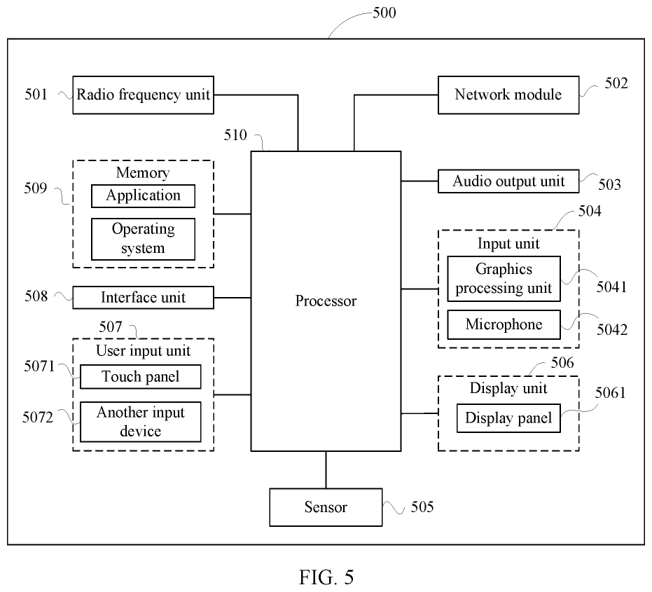

In some embodiments, as shown in FIG. 4, an embodiment of this application further provides a communications device 400, including a processor 401 and a memory 402. The memory 402 stores a program or an instruction that is executable on the processor 401. For example, in a case that the communications device 400 is a terminal, the program or the instruction is executed by the processor 401 to implement the steps of the embodiment of the satellite assistance information obtaining method, and a same technical effect can be achieved. In a case that the communication device 400 is a network side device, the program or the instruction is executed by the processor 401 to implement the steps of the embodiment of the satellite assistance information obtaining method, and a same technical effect can be achieved. To avoid repetition, details are not described herein again.

An embodiment of this application further provides a terminal, including a processor and a communication interface. The communication interface is configured to obtain a first message and a second message by the terminal, where the first message includes at least one piece of satellite assistance information, and the second message includes satellite assistance information for a serving cell.

The processor is configured to determine satellite assistance information for a target cell or a target frequency according to the first message and/or the second message by the terminal, where the target cell is a neighboring cell of the serving cell, the target frequency is a neighboring frequency of a serving frequency, and the serving frequency is a frequency of the serving cell.

The satellite assistance information in the first message is associated with at least one cell, or the satellite assistance information in the first message is associated with at least one frequency.

The terminal embodiment corresponds to the terminal side method embodiment, each implementation process and implementation of the method embodiment can be applied to the terminal embodiment, and a same technical effect can be achieved. Specifically, FIG. 5 is a schematic diagram of a hardware structure of a terminal according to an embodiment of this application.

A terminal 500 includes but is not limited to at least a part of components such as a radio frequency unit 501, a network module 502, an audio output unit 503, an input unit 504, a sensor 505, a display unit 506, a user input unit 507, an interface unit 508, a memory 509, and a processor 510.

A person skilled in the art can understand that the terminal 500 may further include a power supply (such as a battery) that supplies power to each component. The power supply may be logically connected to the processor 510 through a power supply management system, to implement functions such as charging and discharging management, and power consumption management through the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a Graphics Processing Unit (GPU) 5041 and a microphone 5042. The graphics processing unit 5041 processes image data of a static picture or a video obtained by an image capture apparatus (for example, a camera) in a video capture mode or an image capture mode. The display unit 506 may include a display panel 5061, and the display panel 5061 may be configured in a form of a liquid crystal display, an organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 501 may transmit the downlink data to the processor 510 for processing. In addition, the radio frequency unit 501 may send uplink data to the network side device. Usually, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or an instruction and a second storage area for storing data. The first storage area may store an operating system, and an application or an instruction required by at least one function (for example, a sound playing function or an image playing function). In addition, the memory 509 may be a volatile memory or a non-volatile memory, or the memory 509 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 509 in this embodiment of this application includes but is not limited to these memories and any memory of another proper type.

The processor 510 may include one or more processing units. In some embodiments, an application processor and a modem processor are integrated into the processor 510. The application processor mainly processes an operating system, a user interface, an application, and the like. The modem processor mainly processes a wireless communication signal, for example, a baseband processor. It may be understood that, for example, the modem processor may not be integrated into the processor 510.

The radio frequency unit 501 is configured to obtain a first message and a second message by a terminal, where the first message includes at least one piece of satellite assistance information, and the second message includes satellite assistance information for a serving cell.

The processor 510 is configured to determine satellite assistance information for a target cell or a target frequency according to the first message and/or the second message by the terminal, where the target cell is a neighboring cell of the serving cell, the target frequency is a neighboring frequency of a serving frequency, and the serving frequency is a frequency of the serving cell.

The satellite assistance information in the first message is associated with at least one cell, or the satellite assistance information in the first message is associated with at least one frequency.

In some embodiments, in a case that the satellite assistance information in the first message is associated with the at least one cell, the processor 510 is configured to perform any one of the following:
determining, by the terminal, the satellite assistance information for the target cell according to a first list or a second list, where the first list includes first satellite assistance information, the first satellite assistance information includes satellite assistance information for at least one intra-frequency neighboring cell, the second list includes second satellite assistance information, the second satellite assistance information includes satellite assistance information for at least one inter-frequency neighboring cell, a frequency of the intra-frequency neighboring cell is the same as the serving frequency, and a frequency of the inter-frequency neighboring cell is different from the serving frequency;
determining, by the terminal, the satellite assistance information for the target cell according to a third list or a fourth list, where the third list includes first satellite assistance information, the first satellite assistance information includes satellite assistance information for at least one intra-frequency neighboring cell, the fourth list includes third satellite assistance information, the third satellite assistance information includes satellite assistance information for at least one neighboring cell, a frequency of the at least one neighboring cell is a first frequency, and the first frequency is different from the serving frequency;
determining, by the terminal, the satellite assistance information for the target cell according to a fifth list, where the fifth list includes fourth satellite assistance information, and the fourth satellite assistance information includes satellite assistance information for at least one neighboring cell; or
determining, by the terminal, the satellite assistance information for the target cell according to a sixth list, where the sixth list includes fifth satellite assistance information, and the fifth satellite assistance information includes the satellite assistance information for the serving cell and satellite assistance information for at least one neighboring cell.

In some embodiments, in a case that the satellite assistance information in the first message is associated with the at least one frequency, the processor 510 is configured to perform any one of the following:
determining, by the terminal, the satellite assistance information for the target cell or the target frequency according to a seventh list and an eighth list, where the seventh list includes sixth satellite assistance information, the sixth satellite assistance information includes satellite assistance information for at least one neighboring frequency, the neighboring frequency is different from the serving frequency, the eighth list includes at least one piece of first information, and the first information indicates at least one neighboring cell corresponding to each of the at least one neighboring frequency; or
determining, by the terminal, the satellite assistance information for the target cell or the target frequency according to an eighth list and a ninth list, where the ninth list includes seventh satellite assistance information, the seventh satellite assistance information includes satellite assistance information for the serving frequency and satellite assistance information for at least one neighboring frequency, the neighboring frequency is different from the serving frequency, the eighth list includes at least one piece of first information, and the first information indicates at least one neighboring cell corresponding to each of the at least one neighboring frequency.

In some embodiments, the processor 510 is configured to perform any one of the following:
in a case that the target cell is an intra-frequency neighboring cell, determining, by the terminal, the satellite assistance information for the target cell according to the first list and a tenth list, where the tenth list includes information about at least one intra-frequency neighboring cell, and i^{th} satellite assistance information in the first list corresponds to i^{th} information in the tenth list; or
in a case that the target cell is an inter-frequency neighboring cell, determining, by the terminal, the satellite assistance information for the target cell according to the second list and an eleventh list, where the eleventh list includes information about at least one inter-frequency neighboring cell and information about a frequency related to the at least one inter-frequency neighboring cell, and j^{th} satellite assistance information in the second list corresponds to j^{th} information in the eleventh list, where both i and j are positive integers.

In some embodiments, the processor 510 is configured to perform any one of the following:
in a case that the target cell is an intra-frequency neighboring cell, determining, by the terminal, the satellite assistance information for the target cell according to the third list and a tenth list, where the tenth list includes information about at least one intra-frequency neighboring cell, and i^{th} satellite assistance information in the third list corresponds to i^{th} information in the tenth list; or
in a case that a frequency of the target cell is the first frequency, determining, by the terminal, the satellite assistance information for the target cell according to the fourth list and a twelfth list, where the twelfth list includes information about the at least one neighboring cell corresponding to the first frequency, and j^{th} satellite assistance information in the fourth list corresponds to j^{th} information in the twelfth list, where
both i and j are positive integers.

In some embodiments, the processor 510 is configured to perform any one of the following:
determining, by the terminal, the satellite assistance information for the target cell according to the fifth list and a thirteenth list, where the thirteenth list includes information about at least one neighboring cell, and i^{th} satellite assistance information in the fifth list corresponds to i^{th} information in the thirteenth list;
determining, by the terminal, the satellite assistance information for the target cell according to the fifth list, a first indication list, and a second indication list, where the first indication list includes an index (index) or a bitmap (bitmap) corresponding to at least one intra-frequency neighboring cell, the second indication list includes an index or a bitmap corresponding to at least one inter-frequency neighboring cell, an i^{th} index or bitmap in the first indication list indicates that an i^{th} intra-frequency neighboring cell corresponds to m^{th} satellite assistance information in the fifth list, m corresponds to indicated content of the i^{th} index or bitmap, a j^{th} index or bitmap in the second indication list indicates that a j^{th} inter-frequency neighboring cell corresponds to n^{th} satellite assistance information in the fifth list, and n corresponds to indicated content of the j^{th} index or bitmap;
determining, by the terminal, the satellite assistance information for the target cell according to the fifth list, a thirteenth list, and a third indication list, where the thirteenth list includes information about at least one neighboring cell, the third indication list includes an index or a bitmap corresponding to the at least one neighboring cell, an i^{th} index or bitmap in the third indication list indicates that i^{th} information in the thirteenth list corresponds to mi satellite assistance information in the fifth list, and m corresponds to indicated content of the i^{th} index or bitmap;
determining, by the terminal, the satellite assistance information for the target cell according to the fifth list, a thirteenth list, and a fourth indication list, where the thirteenth list includes information about at least one neighboring cell, the fourth indication list includes an index or a bitmap corresponding to satellite assistance information for the at least one neighboring cell, an i^{th} index or bitmap in the fourth indication list indicates that i^{th} satellite assistance information in the fifth list corresponds to mi information in the thirteenth list, and m corresponds to indicated content of the i^{th} index or bitmap; or
determining, by the terminal, the satellite assistance information for the target cell according to the fifth list, a thirteenth list, and a first cell list, where the thirteenth list includes information about at least one neighboring cell, the first cell list includes cell information corresponding to the satellite assistance information for the at least one neighboring cell, the cell information includes at least one of the following: a physical cell identifier PCI and a frequency, the first cell list indicates that i^{th} satellite assistance information in the fifth list corresponds to m^{th} information in the thirteenth list, and m corresponds to indicated content of the first cell list, where
i, j, m, and n are all positive integers.

In some embodiments, the processor 510 is configured to perform any one of the following:
determining, by the terminal, the satellite assistance information for the target cell according to the sixth list and a fourteenth list, where the fourteenth list includes information about the serving cell and information about at least one neighboring cell, and i^{th} satellite assistance information in the satellite assistance information for the at least one neighboring cell in the sixth list corresponds to i^{th} information in the information about the at least one neighboring cell in the fourteenth list;
determining, by the terminal, the satellite assistance information for the target cell according to the sixth list, a fourteenth list, and a fifth indication list, where the fourteenth list includes information about the serving cell and information about at least one neighboring cell, the fifth indication list includes an index or a bitmap of the serving cell and an index or a bitmap corresponding to the at least one neighboring cell, the index or the bitmap corresponding to the serving cell in the fifth indication list indicates that the information about the serving cell in the fourteenth list corresponds to the satellite assistance information for the serving cell in the sixth list, an i^{th} index or bitmap in the index or the bitmap corresponding to the at least one neighboring cell in the fifth indication list indicates that i^{th} information in the information about the at least one neighboring cell in the fourteenth list corresponds to m^{th} satellite assistance information in the satellite assistance information for the at least one neighboring cell in the sixth list, and m corresponds to indicated content of the i^{th} index or bitmap;
determining, by the terminal, the satellite assistance information for the target cell according to the sixth list, a fourteenth list, and a sixth indication list, where the fourteenth list includes information about the serving cell and information about at least one neighboring cell, the sixth indication list includes an index or a bitmap corresponding to the satellite assistance information for the serving cell and an index or a bitmap corresponding to the satellite assistance information for the at least one neighboring cell, the index or the bitmap corresponding to the satellite assistance information for the serving cell in the sixth indication list indicates that the information about the serving cell in the fourteenth list corresponds to the satellite assistance information for the serving cell in the sixth list, an i^{th} index or bitmap in the index or the bitmap corresponding to the satellite assistance information for the at least one neighboring cell in the sixth indication list indicates that i^{th} satellite assistance information in the satellite assistance information for the at least one neighboring cell in the sixth list corresponds to m^{th} information in the information about the at least one neighboring cell in the fourteenth list, and m corresponds to indicated content of the i^{th} index or bitmap; or
determining, by the terminal, the satellite assistance information for the target cell according to the sixth list, a fourteenth list, and a second cell list, where the fourteenth list includes information about the serving cell and information about at least one neighboring cell, the second cell list includes cell information corresponding to the satellite assistance information for the serving cell and cell information corresponding to the satellite assistance information for the at least one neighboring cell, the cell information includes at least one of the following: a PCI and a frequency, a PCI corresponding to the satellite assistance information for the serving cell in the second cell list indicates that the satellite assistance information for the serving cell in the sixth list corresponds to the information about the serving cell in the fourteenth list, an i^{th} PCI in the second cell list indicates that i^{th} satellite assistance information in the satellite assistance information for the at least one neighboring cell in the sixth list corresponds to m^{th} information in the information about the at least one neighboring cell in the fourteenth list, and m corresponds to indicated content of the i^{th} PCI, where
both i and m are positive integers.

In some embodiments, the processor 510 is configured to perform any one of the following:
determining, by the terminal, the satellite assistance information for the target cell or the target frequency according to the seventh list, the eighth list, and a fifteenth list, where the fifteenth list includes information about at least one neighboring frequency, i^{th} satellite assistance information in the seventh list corresponds to i^{th} information in the fifteenth list, and information about an i^{th} neighboring frequency in the fifteenth list corresponds to i^{th} first information in the eighth list;
determining, by the terminal, the satellite assistance information for the target cell or the target frequency according to the seventh list, the eighth list, a fifteenth list, and a seventh indication list, where the fifteenth list includes information about at least one neighboring frequency, the seventh indication list includes an index or a bitmap corresponding to the at least one neighboring frequency, an i^{th} index or bitmap in the seventh indication list indicates that information about an i^{th} neighboring frequency in the fifteenth list corresponds to m^{th} satellite assistance information in the seventh list, m corresponds to indicated content of the i^{th} index or bitmap, and the information about the i^{th} neighboring frequency in the fifteenth list corresponds to i^{th} first information in the eighth list; or
determining, by the terminal, the satellite assistance information for the target cell or the target frequency according to the seventh list, the eighth list, a fifteenth list, and an eighth indication list, where the fifteenth list includes information about at least one neighboring frequency, the eighth indication list includes an index or a bitmap corresponding to the satellite assistance information for the at least one neighboring frequency, an i^{th} index or bitmap in the eighth indication list indicates that i^{th} satellite assistance information in the seventh list corresponds to information about an m^{th} neighboring frequency in the fifteenth list, m corresponds to indicated content of the i^{th} index or bitmap, and information about an i^{th} neighboring frequency in the fifteenth list corresponds to i^{th} first information in the eighth list, where
both i and m are positive integers.

In some embodiments, the processor 510 is configured to perform any one of the following:
determining, by the terminal, the satellite assistance information for the target cell or the target frequency according to the eighth list, the ninth list, and a sixteenth list, where the sixteenth list includes information about the serving frequency and information about at least one neighboring frequency, i^{th} satellite assistance information in the satellite assistance information for the at least one neighboring frequency in the ninth list corresponds to i^{th} information in the information about the at least one neighboring frequency in the sixteenth list, and the i^{th} information in the information about the at least one neighboring frequency in the sixteenth list corresponds to i^{th} first information in the eighth list;
determining, by the terminal, the satellite assistance information for the target cell or the target frequency according to the eighth list, the ninth list, a sixteenth list, and a ninth indication list, where the sixteenth list includes information about the serving frequency and information about at least one neighboring frequency, the ninth indication list includes an index or a bitmap corresponding to the serving frequency and an index or a bitmap corresponding to the at least one neighboring frequency, the index or the bitmap corresponding to the serving frequency in the ninth indication list indicates that the information about the serving frequency in the sixteenth list corresponds to the satellite assistance information for the serving frequency in the ninth list, an i^{th} index or bitmap in the index or the bitmap corresponding to the at least one neighboring frequency in the ninth indication list indicates that i^{th} information in the information about the at least one neighboring frequency in the sixteenth list corresponds to m^{th} satellite assistance information in the satellite assistance information for the at least one neighboring frequency in the ninth list, m corresponds to indicated content of the i^{th} index or bitmap, and the i^{th} information in the information about the at least one neighboring frequency in the sixteenth list corresponds to i^{th} first information in the eighth list; or
determining, by the terminal, the satellite assistance information for the target cell or the target frequency according to the eighth list, the ninth list, a sixteenth list, and a tenth indication list, where the sixteenth list includes information about the serving frequency and information about at least one neighboring frequency, the tenth indication list includes an index or a bitmap corresponding to the satellite assistance information for the serving frequency, and an index or a bitmap corresponding to the satellite assistance information for the at least one neighboring frequency, or a first frequency list, the index or the bitmap corresponding to the satellite assistance information for the serving frequency, or the first frequency list in the tenth indication list indicates that the information about the serving frequency in the sixteenth list corresponds to the satellite assistance information for the serving frequency in the ninth list, an i^{th} index or bitmap in the index or the bitmap corresponding to the satellite assistance information for the at least one neighboring frequency, or first frequency list in the tenth indication list indicates that i^{th} satellite assistance information in the satellite assistance information for the at least one neighboring frequency in the ninth list corresponds to m^{th} information in the information about the at least one neighboring frequency in the sixteenth list, m corresponds to indicated content of the i^{th} index or bitmap, or the first frequency list, the first frequency list includes frequency information of a cell, and i^{th} information in the information about the at least one neighboring frequency in the sixteenth list corresponds to i^{th} first information in the eighth list, where
both i and m are positive integers.

In some embodiments, in a case that the first message and the second message are a same message, the radio frequency unit 501 is configured to:
obtain a first target system information block SIB by the terminal; and
in a case that the first message and the second message are different messages, the radio frequency unit 501 is configured to perform one or more of the following:
obtaining, by the terminal, a part of the first message through the first target SIB, and obtaining, by the terminal, the other part of the first message through a second target SIB; and
obtaining, by the terminal, a part of satellite assistance information for an intra-frequency neighboring cell through a first SIB, obtaining, by the terminal, the other part of the satellite assistance information for the intra-frequency neighboring cell through a first target SIB, obtaining, by the terminal, a part of satellite assistance information for an inter-frequency neighboring cell through a second SIB, and obtaining, by the terminal, the other part of the satellite assistance information for the inter-frequency neighboring cell through a first target SIB.

In some embodiments, the radio frequency unit 501 is further configured to:
re-obtain the first SIB, the second SIB, the first target SIB, and/or the second target SIB by the terminal in a case that the terminal considers that the first SIB and/or the second SIB are/is invalid; and
re-obtain the first SIB, the second SIB, the first target SIB, and/or the second target SIB by the terminal in a case that the terminal considers that the first target SIB and/or the second target SIB are/is invalid.

In some embodiments, the satellite assistance information includes one or more of the following:
ephemeris information;
a common TA parameter;
polarization information for downlink transmission;
polarization information for uplink transmission;
a timing advance reporting indication;
timing advance related information;
a scheduling offset provided by a network side in a case that frame timing of a downlink is inconsistent with frame timing of an uplink on the network side;
a scheduling offset for modifying a timing relationship in an NTN;
cell service stop time;
a cell reference location;
epoch time; and
validity duration of uplink synchronization information.

An embodiment of this application further provides a readable storage medium. The readable storage medium stores a program or an instruction. The program or the instruction is executed by a processor to implement the processes of the embodiment of the satellite assistance information obtaining method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the embodiment of the satellite assistance information obtaining method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the embodiment of the satellite assistance information obtaining method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A satellite assistance information obtaining method, comprising:
obtaining, by a terminal, a first message and a second message, wherein the first message comprises at least one piece of satellite assistance information, and the second message comprises satellite assistance information for a serving cell; and
determining, by the terminal, satellite assistance information for a target cell or a target frequency according to the first message or the second message, wherein the target cell is a neighboring cell of the serving cell, the target frequency is a neighboring frequency of a serving frequency, and the serving frequency is a frequency of the serving cell,
wherein, the satellite assistance information in the first message is associated with at least one cell, or the satellite assistance information in the first message is associated with at least one frequency.

2. The method according to claim 1, wherein when the satellite assistance information in the first message is associated with the at least one cell, the determining, by the terminal, the satellite assistance information for the target cell or the target frequency according to the first message or the second message comprises:
determining, by the terminal, the satellite assistance information for the target cell according to a fifth list, wherein the fifth list comprises fourth satellite assistance information, and the fourth satellite assistance information comprises satellite assistance information for at least one neighboring cell.

3. The method according to claim 1, wherein when the satellite assistance information in the first message is associated with the at least one frequency, the determining, by the terminal, the satellite assistance information for the target cell or the target frequency according to the first message or the second message comprises:
determining, by the terminal, the satellite assistance information for the target cell or the target frequency according to a seventh list and an eighth list, wherein the seventh list comprises sixth satellite assistance information, the sixth satellite assistance information comprises satellite assistance information for at least one neighboring frequency, the neighboring frequency is different from the serving frequency, the eighth list comprises at least one piece of first information, and the first information indicates at least one neighboring cell corresponding to each of the at least one neighboring frequency; or
determining, by the terminal, the satellite assistance information for the target cell or the target frequency according to an eighth list and a ninth list, wherein the ninth list comprises seventh satellite assistance information, the seventh satellite assistance information comprises satellite assistance information for the serving frequency and satellite assistance information for at least one neighboring frequency, the neighboring frequency is different from the serving frequency, the eighth list comprises at least one piece of first information, and the first information indicates at least one neighboring cell corresponding to each of the at least one neighboring frequency.

4. The method according to claim 2, wherein the determining, by the terminal, the satellite assistance information for the target cell according to the fifth list comprises:
determining, by the terminal, the satellite assistance information for the target cell according to the fifth list, a thirteenth list, and a first cell list, wherein the thirteenth list comprises information about at least one neighboring cell, the first cell list comprises cell information corresponding to the satellite assistance information for the at least one neighboring cell, the cell information comprises at least one of the following: a Physical Cell Identifier (PCI) or a frequency, the first cell list indicates that i^{th} satellite assistance information in the fifth list corresponds to m^{th} information in the thirteenth list, and m corresponds to indicated content of the first cell list,
wherein i, j, m, and n are all positive integers.

5. The method according to claim 3, wherein the determining, by the terminal, the satellite assistance information for the target cell or the target frequency according to the seventh list and the eighth list comprises any one of the following:
determining, by the terminal, the satellite assistance information for the target cell or the target frequency according to the seventh list, the eighth list, and a fifteenth list, wherein the fifteenth list comprises information about at least one neighboring frequency, i^{th} satellite assistance information in the seventh list corresponds to i^{th} information in the fifteenth list, and information about an i^{th} neighboring frequency in the fifteenth list corresponds to i^{th} first information in the eighth list;
determining, by the terminal, the satellite assistance information for the target cell or the target frequency according to the seventh list, the eighth list, a fifteenth list, and a seventh indication list, wherein the fifteenth list comprises information about at least one neighboring frequency, the seventh indication list comprises an index or a bitmap corresponding to the at least one neighboring frequency, an i^{th} index or bitmap in the seventh indication list indicates that information about an i^{th} neighboring frequency in the fifteenth list corresponds to m^{th} satellite assistance information in the seventh list, m corresponds to indicated content of the i^{th} index or bitmap, and the information about the i^{th} neighboring frequency in the fifteenth list corresponds to i^{th} first information in the eighth list; or
determining, by the terminal, the satellite assistance information for the target cell or the target frequency according to the seventh list, the eighth list, a fifteenth list, and an eighth indication list, wherein the fifteenth list comprises information about at least one neighboring frequency, the eighth indication list comprises an index or a bitmap corresponding to the satellite assistance information for the at least one neighboring frequency, an i^{th} index or bitmap in the eighth indication list indicates that i^{th} satellite assistance information in the seventh list corresponds to information about an m^{th} neighboring frequency in the fifteenth list, m corresponds to indicated content of the i^{th} index or bitmap, and information about an i^{th} neighboring frequency in the fifteenth list corresponds to i^{th} first information in the eighth list,
wherein, both i and m are positive integers.

6. The method according to claim 3, wherein the determining, by the terminal, the satellite assistance information for the target cell or the target frequency according to the eighth list and the ninth list comprises any one of the following:
determining, by the terminal, the satellite assistance information for the target cell or the target frequency according to the eighth list, the ninth list, and a sixteenth list, wherein the sixteenth list comprises information about the serving frequency and information about at least one neighboring frequency, i^{th} satellite assistance information in the satellite assistance information for the at least one neighboring frequency in the ninth list corresponds to i^{th} information in the information about the at least one neighboring frequency in the sixteenth list, and the i^{th} information in the information about the at least one neighboring frequency in the sixteenth list corresponds to i^{th} first information in the eighth list;
determining, by the terminal, the satellite assistance information for the target cell or the target frequency according to the eighth list, the ninth list, a sixteenth list, and a ninth indication list, wherein the sixteenth list comprises information about the serving frequency and information about at least one neighboring frequency, the ninth indication list comprises an index or a bitmap corresponding to the serving frequency and an index or a bitmap corresponding to the at least one neighboring frequency, the index or the bitmap corresponding to the serving frequency in the ninth indication list indicates that the information about the serving frequency in the sixteenth list corresponds to the satellite assistance information for the serving frequency in the ninth list, an i^{th} index or bitmap in the index or the bitmap corresponding to the at least one neighboring frequency in the ninth indication list indicates that i^{th} information in the information about the at least one neighboring frequency in the sixteenth list corresponds to m^{th} satellite assistance information in the satellite assistance information for the at least one neighboring frequency in the ninth list, m corresponds to indicated content of the i^{th} index or bitmap, and the i^{th} information in the information about the at least one neighboring frequency in the sixteenth list corresponds to i^{th} first information in the eighth list; or
determining, by the terminal, the satellite assistance information for the target cell or the target frequency according to the eighth list, the ninth list, a sixteenth list, and a tenth indication list, wherein the sixteenth list comprises information about the serving frequency and information about at least one neighboring frequency, the tenth indication list comprises an index or a bitmap corresponding to the satellite assistance information for the serving frequency, and an index or a bitmap corresponding to the satellite assistance information for the at least one neighboring frequency, or a first frequency list, the index or the bitmap corresponding to the satellite assistance information for the serving frequency, or the first frequency list in the tenth indication list indicates that the information about the serving frequency in the sixteenth list corresponds to the satellite assistance information for the serving frequency in the ninth list, an i^{th} index or bitmap in the index or the bitmap corresponding to the satellite assistance information for the at least one neighboring frequency, or the first frequency list in the tenth indication list indicates that i^{th} satellite assistance information in the satellite assistance information for the at least one neighboring frequency in the ninth list corresponds to m^{th} information in the information about the at least one neighboring frequency in the sixteenth list, satellite assistance information for an i^{th} neighboring frequency in the ninth list corresponds to m^{th} first information in the eighth list, m corresponds to indicated content of the i^{th} index or bitmap, or the first frequency list, the first frequency list comprises frequency information of a cell, and i^{th} information in the information about the at least one neighboring frequency in the sixteenth list corresponds to i^{th} first information in the eighth list,
wherein, both i and m are positive integers.

7. The method according to claim 1, wherein when the first message and the second message are a same message, the obtaining, by the terminal, the first message and the second message comprises:
obtaining, by the terminal, the first target System Information Block (SIB).

8. The method according to claim 1, wherein the satellite assistance information comprises at least one of the following:
ephemeris information;
a common timing advance TA parameter;
polarization information for downlink transmission;
polarization information for uplink transmission;
a timing advance reporting indication;
timing advance related information;
a scheduling offset provided by a network side when frame timing of a downlink is inconsistent with frame timing of an uplink on the network side;
a scheduling offset for modifying a timing relationship in a Non-Terrestrial Network (NTN);
cell service stop time;
a cell reference location;
epoch time; or
validity duration of uplink synchronization information.

9. A terminal, comprising a processor and a memory storing instructions, wherein the instructions, when executed by the processor, cause the at least one processor to perform operations comprising:
obtaining a first message and a second message, wherein the first message comprises at least one piece of satellite assistance information, and the second message comprises satellite assistance information for a serving cell; and
determining satellite assistance information for a target cell or a target frequency according to the first message or the second message, wherein the target cell is a neighboring cell of the serving cell, the target frequency is a neighboring frequency of a serving frequency, and the serving frequency is a frequency of the serving cell,
wherein the satellite assistance information in the first message is associated with at least one cell, or the satellite assistance information in the first message is associated with at least one frequency.

10. The terminal according to claim 9, wherein when the satellite assistance information in the first message is associated with the at least one cell, the determining the satellite assistance information for the target cell or the target frequency according to the first message or the second message comprises:
determining the satellite assistance information for the target cell according to a fifth list, wherein the fifth list comprises fourth satellite assistance information, and the fourth satellite assistance information comprises satellite assistance information for at least one neighboring cell.

11. The terminal according to claim 9, wherein when the satellite assistance information in the first message is associated with the at least one frequency, the determining the satellite assistance information for the target cell or the target frequency according to the first message or the second message comprises:
determining the satellite assistance information for the target cell or the target frequency according to a seventh list and an eighth list, wherein the seventh list comprises sixth satellite assistance information, the sixth satellite assistance information comprises satellite assistance information for at least one neighboring frequency, the neighboring frequency is different from the serving frequency, the eighth list comprises at least one piece of first information, and the first information indicates at least one neighboring cell corresponding to each of the at least one neighboring frequency; or
determining the satellite assistance information for the target cell or the target frequency according to an eighth list and a ninth list, wherein the ninth list comprises seventh satellite assistance information, the seventh satellite assistance information comprises satellite assistance information for the serving frequency and satellite assistance information for at least one neighboring frequency, the neighboring frequency is different from the serving frequency, the eighth list comprises at least one piece of first information, and the first information indicates at least one neighboring cell corresponding to each of the at least one neighboring frequency.

12. The terminal according to claim 10, wherein the determining the satellite assistance information for the target cell according to the fifth list comprises:
determining the satellite assistance information for the target cell according to the fifth list, a thirteenth list, and a first cell list, wherein the thirteenth list comprises information about at least one neighboring cell, the first cell list comprises cell information corresponding to the satellite assistance information for the at least one neighboring cell, the cell information comprises at least one of the following: a Physical Cell Identifier (PCI) or a frequency, the first cell list indicates that i^{th} satellite assistance information in the fifth list corresponds to m^{th} information in the thirteenth list, and m corresponds to indicated content of the first cell list,
wherein i, j, m, and n are all positive integers.

13. The terminal according to claim 11, wherein the determining the satellite assistance information for the target cell or the target frequency according to the seventh list and the eighth list comprises any one of the following:
determining the satellite assistance information for the target cell or the target frequency according to the seventh list, the eighth list, and a fifteenth list, wherein the fifteenth list comprises information about at least one neighboring frequency, i^{th} satellite assistance information in the seventh list corresponds to i^{th} information in the fifteenth list, and information about an i^{th} neighboring frequency in the fifteenth list corresponds to i^{th} first information in the eighth list;
determining the satellite assistance information for the target cell or the target frequency according to the seventh list, the eighth list, a fifteenth list, and a seventh indication list, wherein the fifteenth list comprises information about at least one neighboring frequency, the seventh indication list comprises an index or a bitmap corresponding to the at least one neighboring frequency, an i^{th} index or bitmap in the seventh indication list indicates that information about an i^{th} neighboring frequency in the fifteenth list corresponds to m^{th} satellite assistance information in the seventh list, m corresponds to indicated content of the i^{th} index or bitmap, and the information about the i^{th} neighboring frequency in the fifteenth list corresponds to i^{th} first information in the eighth list; or
determining the satellite assistance information for the target cell or the target frequency according to the seventh list, the eighth list, a fifteenth list, and an eighth indication list, wherein the fifteenth list comprises information about at least one neighboring frequency, the eighth indication list comprises an index or a bitmap corresponding to the satellite assistance information for the at least one neighboring frequency, an i^{th} index or bitmap in the eighth indication list indicates that i^{th} satellite assistance information in the seventh list corresponds to information about an m^{th} neighboring frequency in the fifteenth list, m corresponds to indicated content of the i^{th} index or bitmap, and information about an i^{th} neighboring frequency in the fifteenth list corresponds to i^{th} first information in the eighth list,
wherein, both i and m are positive integers.

14. The terminal according to claim 9, wherein when the first message and the second message are a same message, the obtaining the first message and the second message comprises:
obtaining the first target System Information Block (SIB).

15. The terminal according to claim 9, wherein the satellite assistance information comprises at least one of the following:
ephemeris information;
a common Timing Advance (TA) parameter;
polarization information for downlink transmission;
polarization information for uplink transmission;
a timing advance reporting indication;
timing advance related information;
a scheduling offset provided by a network side when frame timing of a downlink is inconsistent with frame timing of an uplink on the network side;
a scheduling offset for modifying a timing relationship in a Non-Terrestrial Network (NTN);
cell service stop time;
a cell reference location;
epoch time; or
validity duration of uplink synchronization information.

16. A non-transitory computer-readable storage medium storing instructions, when executed by a processor, cause the processor to perform operations comprising:
obtaining a first message and a second message, wherein the first message comprises at least one piece of satellite assistance information, and the second message comprises satellite assistance information for a serving cell; and
determining satellite assistance information for a target cell or a target frequency according to the first message or the second message, wherein the target cell is a neighboring cell of the serving cell, the target frequency is a neighboring frequency of a serving frequency, and the serving frequency is a frequency of the serving cell,
wherein the satellite assistance information in the first message is associated with at least one cell, or the satellite assistance information in the first message is associated with at least one frequency.

17. The non-transitory computer-readable storage medium according to claim 16, wherein when the satellite assistance information in the first message is associated with the at least one cell, the determining the satellite assistance information for the target cell or the target frequency according to the first message or the second message comprises:
determining the satellite assistance information for the target cell according to a fifth list, wherein the fifth list comprises fourth satellite assistance information, and the fourth satellite assistance information comprises satellite assistance information for at least one neighboring cell.

18. The non-transitory computer-readable storage medium according to claim 17, wherein the determining the satellite assistance information for the target cell according to the fifth list comprises:
determining the satellite assistance information for the target cell according to the fifth list, a thirteenth list, and a first cell list, wherein the thirteenth list comprises information about at least one neighboring cell, the first cell list comprises cell information corresponding to the satellite assistance information for the at least one neighboring cell, the cell information comprises at least one of the following: a Physical Cell Identifier (PCI) or a frequency, the first cell list indicates that i^{th} satellite assistance information in the fifth list corresponds to m^{th} information in the thirteenth list, and m corresponds to indicated content of the first cell list,
wherein i, j, m, and n are all positive integers.

19. The non-transitory computer-readable storage medium according to claim 16, wherein when the first message and the second message are a same message, the obtaining the first message and the second message comprises:
obtaining the first target System Information Block (SIB).

20. The non-transitory computer-readable storage medium according to claim 16, wherein the satellite assistance information comprises at least one of the following:
ephemeris information;
a common timing advance TA parameter;
polarization information for downlink transmission;
polarization information for uplink transmission;
a timing advance reporting indication;
timing advance related information;
a scheduling offset provided by a network side when frame timing of a downlink is inconsistent with frame timing of an uplink on the network side;
a scheduling offset for modifying a timing relationship in a Non-Terrestrial Network (NTN);
cell service stop time;
a cell reference location;
epoch time; or
validity duration of uplink synchronization information.
